(19) United States
(12) Patent Application Publication
(10) Pub. No.: US 2026/0292795 A1
(43) Pub. Date: Sep. 24, 2026

(54) METHOD AND DEVICE FOR TRANSMITTING AND RECEIVING UPLINK DATA CHANNEL IN FULL-DUPLEX COMMUNICATION

(71) Applicant: KT CORPORATION, Gyeonggi-do (KR)

(72) Inventor: Kyu Jin PARK, Gyeonggi-do (KR)

(73) Assignee: KT CORPORATION, Gyeonggi-do (KR)

(21) Appl. No.: 19/474,720

(22) PCT Filed: Apr. 12, 2024
(86) PCT No.: PCT/KR2024/004884

§ 371 Date: Oct. 12, 2025

(30) Foreign Application Priority Data
Apr. 12, 2023 (KR) 10-2023-0048381
Apr. 11, 2024 (KR) 10-2024-0048710

(51) Int. Cl. H04W 72/0446; H04L 5/00; H04L 5/14; H04W 56/00

(52) U.S. Cl. CPC H04W 72/0446; H04L 5/0044; H04L 5/14; H04W 56/0015

(57) ABSTRACT

Provided is a method of a UE for transmitting a PUSCH in full-duplex communication. The method may include: receiving TDD configuration information and subband configuration information; receiving PUSCH configuration information including slot number configuration information for transmission of a PUSCH including one transport block (TB); determining a plurality of slots for transmitting the PUSCH including one transport block on the basis of downlink control information including PUSCH resource allocation information and the PUSCH configuration information; and transmitting the PUSCH including one transport block through the determined plurality of slots.

### TECHNICAL FIELD

The present disclosure relates to methods and devices for transmitting and receiving an uplink data channel in a next-generation radio access network (hereinafter, “new radio (NR)”).

### BACKGROUND ART

Recently, the 3rd generation partnership project (3GPP) has approved the “Study on New Radio Access Technology”, which is a study item for research on next-generation/5G radio access technology (hereinafter, referred to as “new radio” or “NR”). On the basis of the Study on New Radio Access Technology, Radio Access Network Working Group 1 (RAN WG1) has been discussing frame structures, channel coding and modulation, waveforms, multiple access methods, and the like for the new radio (NR). It is required to design the NR not only to provide an improved data transmission rate as compared with the long term evolution (LTE)/LTE-Advanced, but also to meet various requirements in detailed and specific usage scenarios.

An enhanced mobile broadband (eMBB), massive machine-type communication (mMTC), and ultra reliable and low latency communication (URLLC) are proposed as representative usage scenarios of the NR. In order to meet the requirements of the individual scenarios, it is required to design the NR to have flexible frame structures, compared with the LTE/LTE-Advanced.

Because the requirements for data rates, latency, reliability, coverage, etc. are different from each other, there is a need for a method for efficiently multiplexing a radio resource unit based on different numerologies from other (e.g., subcarrier spacing, subframe, Transmission Time Interval (TTI), etc.) as a method for efficiently satisfying each usage scenario requirement through a frequency band constituting any NR system.

As part of this aspect, a need exists for a specific design capable of efficiently performing transmission/reception of an uplink data channel in a symbol where full-duplex communication is applied in a wireless network.

### DETAILED DESCRIPTION OF THE INVENTION

### Technical Problem

The disclosure may provide a method and device for transmitting/receiving an uplink data channel in full-duplex communication.

### Technical Solution

In accordance with an embodiment, the present disclosure may provide a method for a UE transmitting a physical uplink shared channel (PUSCH) in full duplex communication. The method may include receiving time division duplex (TDD) configuration information and subband configuration information, receiving PUSCH configuration information including slot number configuration information for transmission of a PUSCH including one transport block (TB), determining a plurality of slots for transmitting the PUSCH including the one transport block based on downlink control information including the PUSCH configuration information and PUSCH resource allocation information, and transmitting the PUSCH including the one transport block through the determined plurality of slots, wherein the plurality of slots include at least one of a slot where symbols allocated for the PUSCH transmission within each slot are set as non-subband full duplex (non-SBFD) symbols that are all uplink (UL) or flexible according to the TDD configuration information, not including SSB reception symbols, or a slot where the symbols are reset as SBFD symbols set as downlink (DL) or flexible according to the TDD configuration information and where an uplink subband is configured according to the subband configuration information.

In accordance with another embodiment, the present disclosure may provide a method for a base station receiving a physical uplink shared channel (PUSCH) in full duplex communication. The method may include transmitting time division duplex (TDD) configuration information and subband configuration information, transmitting PUSCH configuration information including slot number configuration information for transmission of a PUSCH including one transport block (TB), configuring whether to enable transmission of the PUSCH including the one transport block through slots of different slot types, and receiving the PUSCH including the one transport block through a plurality of slots determined based on whether the transmission of the PUSCH including the one transport block is enabled, wherein the plurality of slots include at least one of a slot where symbols allocated for the PUSCH transmission within each slot are set as non-subband full duplex (non-SBFD) symbols that are all uplink (UL) or flexible according to the TDD configuration information, not including SSB reception symbols, or a slot where the symbols are reset as SBFD symbols set as downlink (DL) or flexible according to the TDD configuration information and where an uplink subband is configured according to the subband configuration information.

In accordance with yet another embodiment, the present disclosure may provide an UE transmitting a physical uplink shared channel (PUSCH) in full duplex communication. The UE may include a transmitter, a receiver, and a controller controlling operations of the transmitter and the receiver, wherein the controller receives time division duplex (TDD) configuration information and subband configuration information, receives PUSCH configuration information including slot number configuration information for transmission of a PUSCH including one transport block (TB), determines a plurality of slots for transmitting the PUSCH including the one transport block based on downlink control information including the PUSCH configuration information and PUSCH resource allocation information, and transmits the PUSCH including the one transport block through the determined plurality of slots, wherein the plurality of slots include at least one of a slot where symbols allocated for the PUSCH transmission within each slot are set as non-subband full duplex (non-SBFD) symbols that are all uplink (UL) or flexible according to the TDD configuration information, not including SSB reception symbols, or a slot where the symbols are reset as SBFD symbols set as downlink (DL) or flexible according to the TDD configuration information and where an uplink subband is configured according to the subband configuration information.

In accordance with further another embodiment, the present disclosure may provide a base station receiving a physical uplink shared channel (PUSCH) in full duplex communication. The base station may include a transmitter, a receiver, and a controller controlling operations of the transmitter and the receiver, wherein the controller transmits time division duplex (TDD) configuration information and subband configuration information, transmits PUSCH configuration information including slot number configuration information for transmission of a PUSCH including one transport block (TB), configures whether to enable transmission of the PUSCH including the one transport block through slots of different slot types, and receives the PUSCH including the one transport block through a plurality of slots determined based on whether the transmission of the PUSCH including the one transport block is enabled, wherein the plurality of slots include at least one of a slot where symbols allocated for the PUSCH transmission within each slot are set as non-subband full duplex (non-SBFD) symbols that are all uplink (UL) or flexible according to the TDD configuration information, not including SSB reception symbols, or a slot where the symbols are reset as SBFD symbols set as downlink (DL) or flexible according to the TDD configuration information and where an uplink subband is configured according to the subband configuration information.

### Advantageous Effects

According to the embodiments, an uplink data channel may be efficiently transmitted or received within a slot or symbol where full-duplex communication is applied.

### BRIEF DESCRIPTION OF DRAWINGS

FIG. 1 is a view schematically illustrating an NR wireless communication system in accordance with embodiments of the present disclosure.

FIG. 2 is a view schematically illustrating a frame structure in an NR system in accordance with embodiments of the present disclosure.

FIG. 3 is a view for explaining resource grids supported by a radio access technology in accordance with embodiments of the present disclosure.

FIG. 4 is a view for explaining bandwidth parts supported by a radio access technology in accordance with embodiments of the present disclosure.

FIG. 5 is a view illustrating an example of a synchronization signal block in a radio access technology in accordance with embodiments of the present disclosure.

FIG. 6 is a signal diagram for explaining a random access procedure in a radio access technology in accordance with embodiments of the present disclosure.

FIG. 7 is a view for explaining CORESET.

FIG. 8 is a flowchart illustrating a method for a UE transmitting an uplink data channel according to an embodiment.

FIG. 9 is a flowchart illustrating a method for a base station receiving an uplink data channel according to an embodiment.

FIGS. 10 and 11 are views illustrating a TDD frame in which an uplink subband is configured in a downlink slot according to an embodiment.

FIG. 12 is a block diagram illustrating a UE according to an embodiment; and

FIG. 13 is a block diagram illustrating a base station according to an embodiment.

### MODE FOR CARRYING OUT THE INVENTION

Hereinafter, some embodiments of the present disclosure will be described in detail with reference to the accompanying illustrative drawings. In the drawings, like reference numerals are used to denote like elements throughout the drawings, even if they are shown on different drawings. Further, in the following description of the present disclosure, a detailed description of known functions and configurations incorporated herein will be omitted when it may make the subject matter of the present disclosure rather unclear. When the expression “include”, “have”, “comprise”, or the like as mentioned herein is used, any other part may be added unless the expression “only” is used. When an element is expressed in the singular, the element may cover the plural form unless a special mention is explicitly made of the element.

In addition, terms, such as first, second, A, B, (A), (B) or the like may be used herein when describing components of the present disclosure. Each of these terminologies is not used to define an essence, order or sequence of a corresponding component but used merely to distinguish the corresponding component from other component(s).

In describing the positional relationship between components, if two or more components are described as being “connected”, “combined”, or “coupled” to each other, it should be understood that two or more components may be directly “connected”, “combined”, or “coupled” to each other, and that two or more components may be “connected”, “combined”, or “coupled” to each other with another component “interposed” therebetween. In this case, another component may be included in at least one of the two or more components that are “connected”, “combined”, or “coupled” to each other.

In the description of a sequence of operating methods or manufacturing methods, for example, the expressions using “after”, “subsequent to”, “next”, “before”, and the like may also encompass the case in which operations or processes are performed discontinuously unless “immediately” or “directly” is used in the expression.

Numerical values for components or information corresponding thereto (e.g., levels or the like), which are mentioned herein, may be interpreted as including an error range caused by various factors (e.g., process factors, internal or external impacts, noise, etc.) even if an explicit description thereof is not provided.

The wireless communication system in the present specification refers to a system for providing various communication services, such as a voice service and a data service, using radio resources. The wireless communication system may include a user equipment (UE), a base station, a core network, and the like.

Embodiments disclosed below may be applied to a wireless communication system using various radio access technologies. For example, the embodiments may be applied to various radio access technologies such as code division multiple access (CDMA), frequency division multiple access (FDMA), time division multiple access (TDMA), orthogonal frequency division multiple access (OFDMA), single-carrier frequency division multiple access (SC-FDMA), non-orthogonal multiple access (NOMA), or the like. In addition, the radio access technology may refer to respective generation communication technologies established by various communication organizations, such as 3GPP, 3GPP2, Wi-Fi, Bluetooth, IEEE, ITU, or the like, as well as a specific access technology. For example, CDMA may be implemented as a wireless technology such as universal terrestrial radio access (UTRA) or CDMA2000. TDMA may be implemented as a wireless technology such as global system for mobile communications (GSM)/general packet radio service (GPRS)/enhanced data rates for GSM evolution (EDGE). OFDMA may be implemented as a wireless technology such as IEEE (Institute of Electrical and Electronics Engineers) 802.11 (Wi-Fi), IEEE 802.16 (WiMAX), IEEE 802-20, evolved UTRA (E-UTRA), and the like. IEEE 802.16m is evolution of IEEE 802.16e, which provides backward compatibility with systems based on IEEE 802.16e. UTRA is a part of a universal mobile telecommunications system (UMTS). 3GPP (3rd-generation partnership project) LTE (long-term evolution) is a part of E-UMTS (evolved UMTS) using evolved-UMTS terrestrial radio access (E-UTRA), which adopts OFDMA in a downlink and SC-FDMA in an uplink. As described above, the embodiments may be applied to radio access technologies that have been launched or commercialized, and may be applied to radio access technologies that are being developed or will be developed in the future.

The UE used in the specification must be interpreted as a broad meaning that indicates a device including a wireless communication module that communicates with a base station in a wireless communication system. For example, the UE includes user equipment (UE) in WCDMA, LTE, NR, HSPA, IMT-2020 (5G or New Radio), and the like, a mobile station in GSM, a user terminal (UT), a subscriber station (SS), a wireless device, and the like. In addition, the UE may be a portable user device, such as a smart phone, or may be a vehicle, a device including a wireless communication module in the vehicle, and the like in a V2X communication system according to the usage type thereof. In the case of a machine-type communication (MTC) system, the UE may refer to an MTC terminal, an M2M terminal, or a URLLC terminal, which employs a communication module capable of performing machine-type communication.

A base station or a cell in the present specification refers to an end that communicates with a UE through a network and encompasses various coverage regions such as a Node-B, an evolved Node-B (eNB), a gNode-B, a low-power node (LPN), a sector, a site, various types of antennas, a base transceiver system (BTS), an access point, a point (e.g., a transmission point, a reception point, or a transmission/reception point), a relay node, a megacell, a macrocell, a microcell, a picocell, a femtocell, a remote radio head (RRH), a radio unit (RU), a small cell, and the like. In addition, the cell may be used as a meaning including a bandwidth part (BWP) in the frequency domain. For example, the serving cell may refer to an active BWP of a UE.

The various cells listed above are provided with a base station controlling one or more cells, and the base station may be interpreted as two meanings. The base station may be 1) a device for providing a megacell, a macrocell, a microcell, a picocell, a femtocell, or a small cell in connection with a wireless region, or the base station may be 2) a wireless region itself. In the above description 1), the base station may be the devices controlled by the same entity and providing predetermined wireless regions or all devices interacting with each other and cooperatively configuring a wireless region. For example, the base station may be a point, a transmission/reception point, a transmission point, a reception point, and the like according to the configuration method of the wireless region. In the above description 2), the base station may be the wireless region in which a user equipment (UE) may be enabled to transmit data to and receive data from the other UE or a neighboring base station.

In this specification, the cell may refer to coverage of a signal transmitted from a transmission/reception point, a component carrier having coverage of a signal transmitted from a transmission/reception point (or a transmission point), or a transmission/reception point itself.

An uplink (UL) refers to a scheme of transmitting data from a UE to a base station, and a downlink (DL) refers to a scheme of transmitting data from a base station to a UE. The downlink may mean communication or communication paths from multiple transmission/reception points to a UE, and the uplink may mean communication or communication paths from a UE to multiple transmission/reception points. In the downlink, a transmitter may be a part of the multiple transmission/reception points, and a receiver may be a part of the UE. In addition, in the uplink, the transmitter may be a part of the UE, and the receiver may be a part of the multiple transmission/reception points.

The uplink and downlink transmit and receive control information over a control channel, such as a physical downlink control channel (PDCCH) and a physical uplink control channel (PUCCH). The uplink and downlink transmit and receive data over a data channel such as a physical downlink shared channel (PDSCH) and a physical uplink shared channel (PUSCH). Hereinafter, the transmission and reception of a signal over a channel, such as PUCCH, PUSCH, PDCCH, PDSCH, or the like, may be expressed as “PUCCH, PUSCH, PDCCH, PDSCH, or the like is transmitted and received”.

For the sake of clarity, the following description will focus on 3GPP LTE/LTE-A/NR (New Radio) communication systems, but technical features of the disclosure are not limited to the corresponding communication systems.

The 3GPP has been developing a 5G (5th-Generation) communication technology in order to meet the requirements of a next-generation radio access technology of ITU-R after studying 4G (4th-generation) communication technology. Specifically, 3GPP is developing, as a 5G communication technology, LTE-A pro by improving the LTE-Advanced technology so as to conform to the requirements of ITU-R and a new NR communication technology that is totally different from 4G communication technology. LTE-A pro and NR all refer to the 5G communication technology. Hereinafter, the 5G communication technology will be described on the basis of NR unless a specific communication technology is specified.

Various operating scenarios have been defined in NR in consideration of satellites, automobiles, new verticals, and the like in the typical 4G LTE scenarios so as to support an enhanced mobile broadband (eMBB) scenario in terms of services, a massive machine-type communication (mMTC) scenario in which UEs spread over a broad region at a high UE density, thereby requiring low data rates and asynchronous connections, and an ultra-reliability and low-latency (URLLC) scenario that requires high responsiveness and reliability and supports high-speed mobility.

In order to satisfy such scenarios, NR introduces a wireless communication system employing a new waveform and frame structure technology, a low-latency technology, a super-high frequency band (mmWave) support technology, and a forward compatible provision technology. In particular, the NR system has various technological changes in terms of flexibility in order to provide forward compatibility. The primary technical features of NR will be described below with reference to the drawings.

### <Overview of NR System>

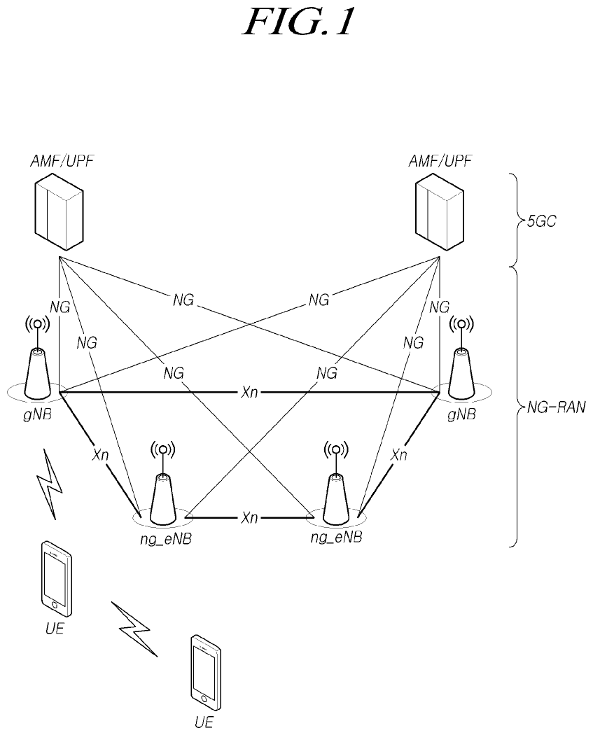

FIG. 1 is a view schematically illustrating an NR system to which the present embodiment is applicable.

Referring to FIG. 1, the NR system is divided into a 5G core network (5GC) and an NG-RAN part. The NG-RAN includes gNBs and ng-eNBs providing user plane (SDAP/PDCP/RLC/MAC/PHY) and user equipment (UE) control plane (RRC) protocol ends. The gNBs or the gNB and the ng-eNB are connected to each other through Xn interfaces. The gNB and the ng-eNB are connected to the 5GC through NG interfaces, respectively. The 5GC may be configured to include an access and mobility management function (AMF) for managing a control plane, such as a UE connection and mobility control function, and a user plane function (UPF) controlling user data. NR supports both frequency bands below 6 GHz (frequency range 1 FR1) and frequency bands equal to or greater than 6 GHz (frequency range 2 FR2).

The gNB denotes a base station that provides a UE with an NR user plane and control plane protocol end. The ng-eNB denotes a base station that provides a UE with an E-UTRA user plane and control plane protocol end. The base station described in the present specification should be understood as encompassing the gNB and the ng-eNB. However, the base station may be also used to refer to the gNB or the ng-eNB separately from each other, as necessary.

### <NR Waveform, Numerology, and Frame Structure>

NR uses a CP-OFDM waveform using a cyclic prefix for downlink transmission and uses CP-OFDM or DFT-s-OFDM for uplink transmission. OFDM technology is easy to combine with a multiple-input multiple-output (MIMO) scheme and allows a low-complexity receiver to be used with high frequency efficiency.

Since the three scenarios described above have different requirements for data rates, delay rates, coverage, and the like from each other in NR, it is necessary to efficiently satisfy the requirements for each scenario over frequency bands constituting the NR system. To this end, a technique for efficiently multiplexing radio resources based on a plurality of different numerologies has been proposed.

Specifically, the NR transmission numerology is determined on the basis of subcarrier spacing and a cyclic prefix (CP). As shown in Table 1 below, “u” is used as an exponential value of 2 so as to be changed exponentially on the basis of 15 kHz.

TABLE 1

| | Subcarrier | | Supported for | Supported for |
|---|---|---|---|---|
| μ | spacing | Cyclic prefix | data | synch |
| 0 | 15 | normal | Yes | Yes |
| 1 | 30 | normal | Yes | Yes |
| 2 | 60 | Normal, | Yes | No |
| | | Extended | | |
| 3 | 120 | normal | Yes | Yes |
| 4 | 240 | normal | No | Yes |

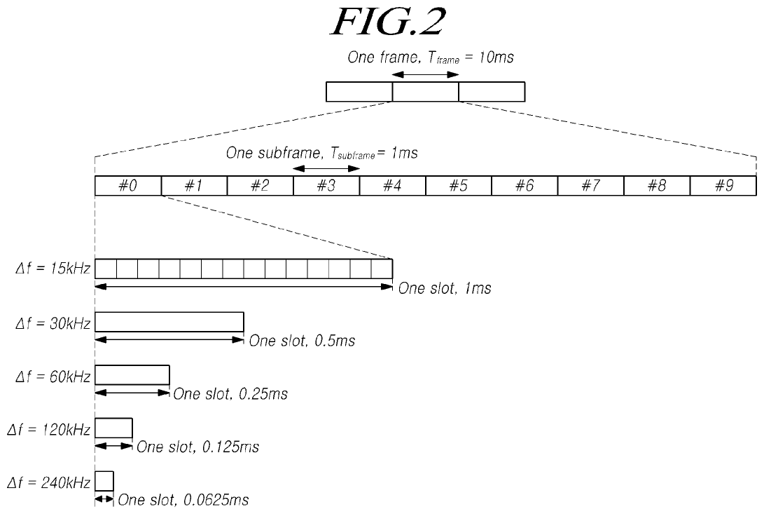

As shown in Table 1 above, NR may have five types of numerologies according to subcarrier spacing. This is different from LTE, which is one of the 4G-communication technologies, in which the subcarrier spacing is fixed to 15 kHz. Specifically, in NR, subcarrier spacing used for data transmission is 15, 30, 60, or 120 kHz, and subcarrier spacing used for synchronization signal transmission is 15, 30, 120, or 240 kHz. In addition, an extended CP is applied only to the subcarrier spacing of 60 KHz. A frame that includes 10 subframes each having the same length of 1 ms and has a length of 10 ms is defined in the frame structure in NR. One frame may be divided into half frames of 5 ms, and each half frame includes 5 subframes. In the case of a subcarrier spacing of 15 kHz, one subframe includes one slot, and each slot includes 14 OFDM symbols. FIG. 2 is a view for explaining a frame structure in an NR system to which the present embodiment may be applied. Referring to FIG. 2, a slot includes 14 OFDM symbols, which are fixed, in the case of a normal CP, but the length of the slot in the time domain may be varied depending on subcarrier spacing. For example, in the case of a numerology having a subcarrier spacing of 15 kHz, the slot is configured to have the same length of 1 ms as that of the subframe. On the other hand, in the case of a numerology having a subcarrier spacing of 30 kHz, the slot includes 14 OFDM symbols, but one subframe may include two slots each having a length of 0.5 ms. That is, the subframe and the frame may be defined using a fixed time length, and the slot may be defined as the number of symbols such that the time length thereof is varied depending on the subcarrier spacing.

NR defines a basic unit of scheduling as a slot and also introduces a minislot (or a subslot or a non-slot-based schedule) in order to reduce a transmission delay of a radio section. If wide subcarrier spacing is used, the length of one slot is shortened in inverse proportion thereto, thereby reducing a transmission delay in the radio section. A minislot (or subslot) is intended to efficiently support URLLC scenarios, and the minislot may be scheduled in 2, 4, or 7 symbol units.

In addition, unlike LTE, NR defines uplink and downlink resource allocation as a symbol level in one slot. In order to reduce a HARQ delay, the slot structure capable of directly transmitting HARQ ACK/NACK in a transmission slot has been defined. Such a slot structure is referred to as a “self-contained structure”, which will be described.

NR was designed to support a total of 256 slot formats, and 62 slot formats thereof are used in 3GPP Rel-15. In addition, NR supports a common frame structure constituting an FDD or TDD frame through combinations of various slots. For example, NR supports i) a slot structure in which all symbols of a slot are configured for a downlink, ii) a slot structure in which all symbols are configured for an uplink, and iii) a slot structure in which downlink symbols and uplink symbols are mixed. In addition, NR supports data transmission that is scheduled to be distributed to one or more slots. Accordingly, the base station may inform the UE of whether the slot is a downlink slot, an uplink slot, or a flexible slot using a slot format indicator (SFI). The base station may inform a slot format by instructing, using the SFI, the index of a table configured through UE-specific RRC signaling. Further, the base station may dynamically instruct the slot format through downlink control information (DCI) or may statically or quasi-statically instruct the same through RRC signaling.

### <Physical Resources of NR>

With regard to physical resources in NR, antenna ports, resource grids, resource elements, resource blocks, bandwidth parts, and the like are taken into consideration.

The antenna port is defined to infer a channel carrying a symbol on an antenna port from the other channel carrying another symbol on the same antenna port. If large-scale properties of a channel carrying a symbol on an antenna port can be inferred from the other channel carrying a symbol on another antenna port, the two antenna ports may have a quasi-co-located or quasi-colocation (QC/QCL) relationship. The large-scale properties include at least one of delay spread, Doppler spread, a frequency shift, an average received power, and a received timing.

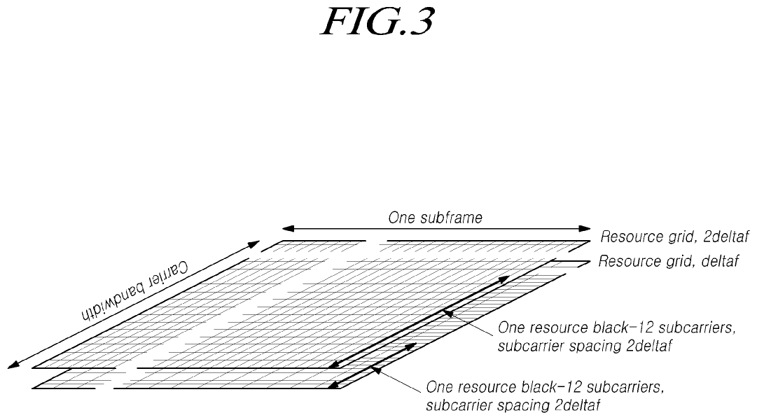

FIG. 3 illustrates resource grids supported by a radio access technology in accordance with embodiments of the present disclosure.

Referring to FIG. 3, resource grids may exist according to respective numerologies because NR supports a plurality of numerologies in the same carrier. In addition, the resource grids may exist depending on antenna ports, subcarrier spacing, and transmission directions.

A resource block includes 12 subcarriers and is defined only in the frequency domain. In addition, a resource element includes one OFDM symbol and one subcarrier. Therefore, as shown in FIG. 3, the size of one resource block may be varied according to the subcarrier spacing. Further, “Point A” that acts as a common reference point for the resource block grids, a common resource block, and a virtual resource block are defined in NR.

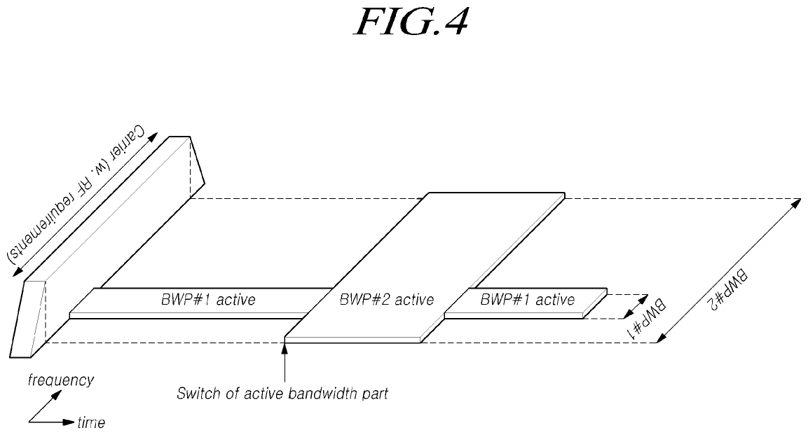

FIG. 4 illustrates bandwidth parts supported by a radio access technology in accordance with embodiments of the present disclosure.

Unlike LTE in which the carrier bandwidth is fixed to 20 MHz, the maximum carrier bandwidth is configured as 50 MHz to 400 MHz depending on the subcarrier spacing in NR. Therefore, it is not assumed that all UEs use the entire carrier bandwidth. Accordingly, as shown in FIG. 4, bandwidth parts (BWPs) may be specified within the carrier bandwidth in NR so that the UE may use the same. In addition, the bandwidth part may be associated with one numerology, may include a subset of consecutive common resource blocks, and may be activated dynamically over time. The UE has up to four bandwidth parts in each of the uplink and the downlink. The UE transmits and receives data using an activated bandwidth part during a given time.

In the case of a paired spectrum, uplink and downlink bandwidth parts are configured independently. In the case of an unpaired spectrum, in order to prevent unnecessary frequency re-tuning between a downlink operation and an uplink operation, the downlink bandwidth part and the uplink bandwidth part are configured in pairs to share a center frequency.

### <Initial Access in NR>

In NR, a UE performs a cell search and a random access procedure in order to access and communicates with a base station.

The cell search is a procedure of the UE for synchronizing with a cell of a corresponding base station using a synchronization signal block (SSB) transmitted from the base station and acquiring a physical-layer cell ID and system information.

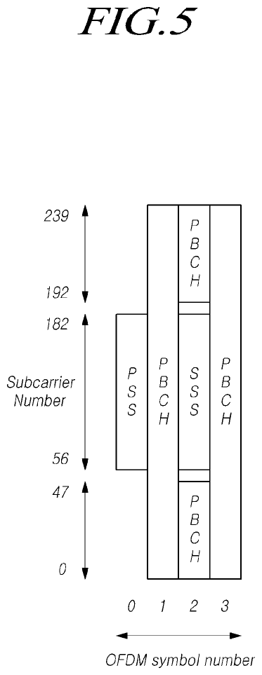

FIG. 5 illustrates an example of a synchronization signal block in a radio access technology in accordance with embodiments of the present disclosure.

Referring to FIG. 5, the SSB includes a primary synchronization signal (PSS) and a secondary synchronization signal (SSS), which occupy one symbol and 127 subcarriers, and PBCHs spanning three OFDM symbols and 240 subcarriers.

The UE monitors the SSB in the time and frequency domain, thereby receiving the SSB.

The SSB may be transmitted up to 64 times for 5 ms. A plurality of SSBs are transmitted by different transmission beams within a time of 5 ms, and the UE performs detection on the assumption that the SSB is transmitted every 20 ms based on a specific beam used for transmission. The number of beams that may be used for SSB transmission within 5 ms may be increased as the frequency band is increased. For example, up to 4 SSB beams may be transmitted at a frequency band of 3 GHz or less, and up to 8 SSB beams may be transmitted at a frequency band of 3 to 6 GHz. In addition, the SSBs may be transmitted using up to 64 different beams at a frequency band of 6 GHz or more.

One slot includes two SSBs, and a start symbol and the number of repetitions in the slot are determined according to subcarrier spacing as follows.

Unlike the SS in the typical LTE system, the SSB is not transmitted at the center frequency of a carrier bandwidth. That is, the SSB may also be transmitted at the frequency other than the center of the system band, and a plurality of SSBs may be transmitted in the frequency domain in the case of supporting a broadband operation. Accordingly, the UE monitors the SSB using a synchronization raster, which is a candidate frequency position for monitoring the SSB. A carrier raster and a synchronization raster, which are the center frequency position information of the channel for the initial connection, were newly defined in NR, and the synchronization raster may support a fast SSB search of the UE because the frequency spacing thereof is configured to be wider than that of the carrier raster.

The UE may acquire an MIB over the PBCH of the SSB. The MIB (master information block) includes minimum information for the UE to receive remaining minimum system information (RMSI) broadcast by the network. In addition, the PBCH may include information on the position of the first DM-RS symbol in the time domain, information for the UE to monitor SIB1 (e.g., SIB1 numerology information, information related to SIB1 CORESET, search space information, PDCCH-related parameter information, etc.), offset information between the common resource block and the SSB (the position of an absolute SSB in the carrier is transmitted via SIB1), and the like. The SIB1 numerology information is also applied to some messages used in the random access procedure for the UE to access the base station after completing the cell search procedure. For example, the numerology information of SIB1 may be applied to at least one of the messages 1 to 4 for the random access procedure.

The above-mentioned RMSI may mean SIB1 (system information block 1), and SIB1 is broadcast periodically (e.g., 160 ms) in the cell. SIB1 includes information necessary for the UE to perform the initial random access procedure, and SIB1 is periodically transmitted over a PDSCH. In order to receive SIB1, the UE must receive numerology information used for the SIB1 transmission and the CORESET (control resource set) information used for scheduling of SIB1 over a PBCH. The UE identifies scheduling information for SIB1 using SI-RNTI in the CORESET. The UE acquires SIB1 on the PDSCH according to scheduling information. The remaining SIBs other than SIB1 may be periodically transmitted, or the remaining SIBs may be transmitted according to the request of the UE.

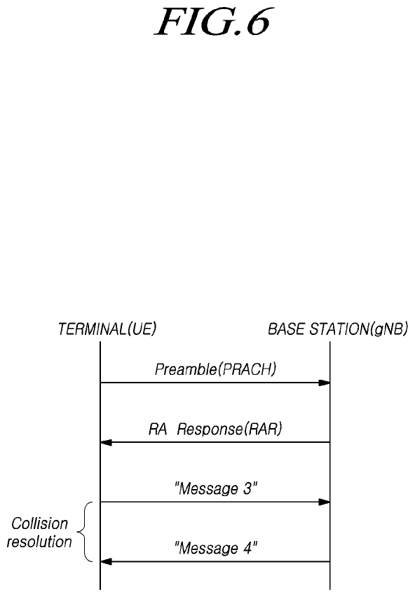

FIG. 6 is a view for explaining a random access procedure in a radio access technology to which the present embodiment is applicable.

Referring to FIG. 6, if a cell search is completed, the UE transmits a random access preamble for random access to the base station. The random access preamble is transmitted over a PRACH. Specifically, the random access preamble is periodically transmitted to the base station over the PRACH that includes consecutive radio resources in a specific slot repeated. In general, a contention-based random access procedure is performed when the UE makes initial access to a cell, and a non-contention-based random access procedure is performed when the UE performs random access for beam failure recovery (BFR).

The UE receives a random access response to the transmitted random access preamble. The random access response may include a random access preamble identifier (ID), UL Grant (uplink radio resource), a temporary C-RNTI (temporary cell-radio network temporary identifier), and a TAC (time alignment command). Since one random access response may include random access response information for one or more UEs, the random access preamble identifier may be included in order to indicate the UE for which the included UL Grant, temporary C-RNTI, and TAC are valid. The random access preamble identifier may be an identifier of the random access preamble received by the base station. The TAC may be included as information for the UE to adjust uplink synchronization. The random access response may be indicated by a random access identifier on the PDCCH, i.e., a random access-radio network temporary identifier (RA-RNTI).

Upon receiving a valid random access response, the UE processes information included in the random access response and performs scheduled transmission to the base station. For example, the UE applies the TAC and stores the temporary C-RNTI. In addition, the UE transmits, to the base station, data stored in the buffer of the UE or newly generated data using the UL Grant. In this case, information for identifying the UE must be included in the data.

Lastly, the UE receives a downlink message to resolve the contention.

### <NR CORESET>

The downlink control channel in NR is transmitted in a CORESET (control resource set) having a length of 1 to 3 symbols, and the downlink control channel transmits uplink/downlink scheduling information, an SFI (slot format index), TPC (transmit power control) information, and the like.

As described above, NR has introduced the concept of CORESET in order to secure the flexibility of a system. The CORESET (control resource set) refers to a time-frequency resource for a downlink control signal. The UE may decode a control channel candidate using one or more search spaces in the CORESET time-frequency resource. CORESET-specific QCL (quasi-colocation) assumption is configured and is used for the purpose of providing information on the characteristics of analogue beam directions, as well as delay spread, Doppler spread, Doppler shift, and an average delay, which are the characteristics assumed by existing QCL.

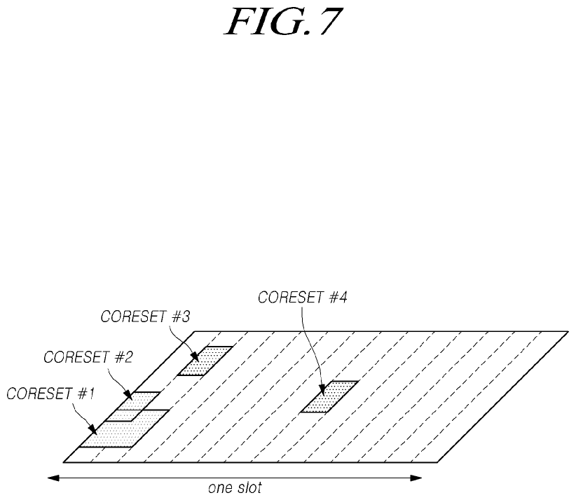

FIG. 7 illustrates CORESET.

Referring to FIG. 7, CORESETs may exist in various forms within a carrier bandwidth in a single slot, and the CORESET may include a maximum of 3 OFDM symbols in the time domain. In addition, the CORESET is defined as a multiple of six resource blocks up to the carrier bandwidth in the frequency domain.

A first CORESET, as a portion of the initial bandwidth part, is designated (e.g., instructed, assigned) through an MIB in order to receive additional configuration information and system information from a network. After establishing a connection with the base station, the UE may receive and configure one or more pieces of CORESET information through RRC signaling.

### Wider Bandwidth Operations

The typical LTE system supports scalable bandwidth operations for any LTE CC (component carrier). That is, according to a frequency deployment scenario, an LTE provider may configure a bandwidth of a minimum of 1.4 MHz to a maximum of 20 MHz in configuring a single LTE CC, and a normal LTE UE supports a transmission/reception capability of a bandwidth of 20 MHz for a single LTE CC.

However, the NR is designed to support the UE of NR having different transmission/reception bandwidth capabilities over a single wideband NR CC. Accordingly, it is required to configure one or more bandwidth parts (BWPs) including subdivided bandwidths for an NR CC, thereby supporting a flexible and wider bandwidth operation through configuration and activation of different bandwidth parts for respective UEs.

Specifically, one or more bandwidth parts may be configured through a single serving cell configured for a UE in NR, and the UE is defined to activate one downlink (DL) bandwidth part and one uplink (UL) bandwidth part to use the same for uplink/downlink data transmission/reception in the corresponding serving cell. In addition, in the case where a plurality of serving cells is configured for the UE (i.e., the UE to which CA is applied), the UE is also defined to activate one downlink bandwidth part and/or one uplink bandwidth part in each serving cell to use the same for uplink/downlink data transmission/reception by utilizing radio resources of the corresponding serving cell.

Specifically, an initial bandwidth part for an initial access procedure of a UE may be defined in a serving cell; one or more UE-specific bandwidth parts may be configured for each UE through dedicated RRC signaling, and a default bandwidth part for a fallback operation may be defined for each UE.

It is possible to define simultaneously activating and using a plurality of downlink and/or uplink bandwidth parts according to the capability of the UE and the configuration of the bandwidth parts in a serving cell. However, NR rel-15 defined activating and using only one downlink (DL) bandwidth part and one uplink (UL) bandwidth part at a time.

In this specification, a frequency, a frame, a subframe, a resource, a resource block, a region, a band, a subband, a control channel, a data channel, a synchronization signal, various reference signals, various signals, or various messages in relation to NR (New Radio) may be interpreted as meanings used at present or in the past or as various meanings to be used in the future.

Hereinafter, a method for a UE to transmit an uplink data channel in full-duplex communication is described with reference to the accompanying drawings.

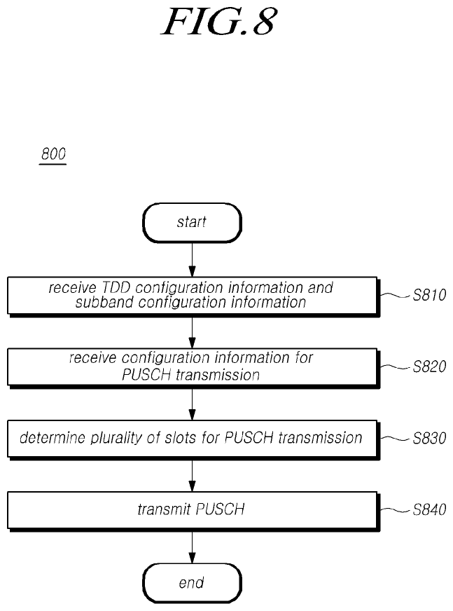

FIG. 8 is a flowchart illustrating a method 800 for a UE to transmit an uplink data channel according to an embodiment.

Referring to FIG. 8, the UE may receive time division duplex (TDD) configuration information and subband configuration information (S810).

The time division duplex (TDD) uses time-domain radio resources by dividing them to downlink and uplink slots, and the UE may receive the TDD configuration information from the base station to determine the format of the symbol within a slot. In this case, the TDD configuration information may include configuration information about the format of the slot and configuration information for determining the symbol format within the slot, and the corresponding information may be received through higher layer signaling or physical layer L1 signaling.

In other words, a downlink symbol, an uplink symbol, and a flexible symbol of a predetermined period in which the transmission direction is not determined may be configured through an RRC message for configuring a corresponding UL-DL slot. Further, the UE may receive UE-specific RRC signaling that reallocates flexible symbols among symbols configured through cell-specific RRC signaling to uplink symbols, downlink symbols, or flexible symbols for each UE.

Alternatively, the UE may receive an indication of a dynamic slot format through a UE-group common PDCCH. According to an embodiment, the UE may dynamically receive the slot format through DCI format 2_0.

Full-duplex communication is a technique in which the base station simultaneously performs downlink transmission and uplink reception in the same radio resource. The UE may also simultaneously perform downlink reception and uplink transmission. When the base station supports full-duplex communication based on subband non-overlapping, a specific frequency resource in the same symbol of a TDD carrier may be used for downlink transmission, and another frequency resource may be used for uplink reception. In other words, for a TDD carrier, some frequency resources may be utilized for uplink transmission of the UE in a downlink slot or downlink symbol, or may be utilized as a flexible symbol for downlink/uplink transition.

To that end, the UE may receive subband configuration information for full-duplex communication. In other words, the UE may receive configuration information for configuring a downlink subband in an uplink slot or an uplink subband in a downlink slot. The subband configuration information may include time-domain information and frequency-domain information where an uplink subband or a downlink subband is configured. Alternatively, the subband configuration information may include frequency-domain information and time-domain information where a guard band is configured.

The subband configuration information may be transmitted through a broadcasting scheme transmitted to all the UEs in the cell. Alternatively, it may be transmitted through a multi-casting scheme that transmits to UEs requiring a full-duplex communication mode operation or a unicasting scheme that transmits only to a specific UE. The UE may receive the corresponding configuration information according to the configured scheme.

For example, when an uplink subband is configured in a downlink slot, the uplink subband may be set at the center of the corresponding frequency band or at the edge of the corresponding frequency band. In this case, a guard band may be configured between the uplink subband and downlink subband (e.g., the remaining frequency band other than the uplink subband and guard band among the frequency bands allocated to the UE) in the corresponding slot.

As such, a downlink slot or symbol including an uplink subband and an uplink slot or symbol including a downlink subband is defined as a subband full duplex (SBFD) slot or SBFD symbol in the disclosure. However, the term SBFD is for convenience of description, and the scope of this disclosure is not limited thereto and may alternatively be expressed using other terms. Further, a slot that is not an SBFD slot, i.e., a slot without subbands configured may be referred to as a non-SBFD slot.

In other words, a downlink slot or downlink symbol configured for the UE may include an SBFD symbol in which an uplink subband is configured for full-duplex communication. That is, an uplink subband may be configured for at least some of the downlink slots or downlink symbols configured for the UE, and in this case, an uplink subband, a downlink subband, and/or a guardband may be configured for the corresponding slot or symbol.

Similarly, an uplink slot or uplink symbol configured for the UE may include an SBFD symbol in which a downlink subband is configured for full-duplex communication. That is, a downlink subband may be configured for at least some of the uplink slots or uplink symbols configured for the UE, and in this case, an uplink subband, a downlink subband, and/or a guardband may be configured for the corresponding slot or symbol.

Referring back to FIG. 8, the UE may receive PUSCH configuration information that includes slot number configuration information for transmission of a PUSCH including one transport block (TB) (S820).

The UE may receive from the base station the PUSCH configuration information configuring or indicating transmission of one transport block across a plurality of slots. That is, for PUSCH transmission, TB processing over multiple slots (TBoMS) may be configured or indicated. To that end, an information element configured in RRC, e.g., PUSCH-TimeDomainResourceAllocationList, may include time domain allocation configuration information areas.

In this case, the time domain allocation configuration information may include configuration information about the numbers of slots that transmit one transport block. According to an embodiment, the number of slots may be configured as 1 (in case of conventional single slot processing), 2, 4, or 8 consecutive slots.

Referring back to FIG. 8, the UE may determine a plurality of slots for transmitting the PUSCH including the one transport block based on the downlink control information including the PUSCH configuration information and the PUSCH resource allocation information (S830). The UE may transmit the PUSCH including the one transport block through the determined plurality of slots (S840).

The UE may be indicated by the base station through a time domain resource assignment (TDRA) indication information area (e.g., information field) of DCI, i.e., an uplink grant (UL grant), such that a single transport block for the corresponding PUSCH transmission is transmitted across multiple slots. In other words, one time domain allocation configuration information among the time domain allocation configuration information areas (e.g., information field) belonging to the above-described PUSCH-TimeDomainResourceAllocationList may be indicated through the time domain resource allocation indication information area. In this case, when the corresponding time domain allocation information includes information indicating the number of a slots across which one transport block is transmitted, it may be configured and indicated that the corresponding one transport block, i.e., the corresponding PUSCH transmission, is performed through consecutive slots corresponding to one of 1, 2, 4, or 8 according to the configuration value of the information about the number of the plurality of slots.

As such, when one PUSCH transmission is performed through a plurality of slots through TBoMS configuration or indication, slots configured or indicated for uplink transmission at the UE may belong to different slot types. For example, assume a case where PUSCH transmission is configured or indicated to be performed across 8 consecutive slots for TBoMS. When 8 slots configured or indicated to enable uplink transmission at the UE from the slot where PUSCH transmission starts include both SBFD slots and non-SBFD slots, a plurality of slots in which one transport block is transmitted may be determined according to whether PUSCH repetitive transmission across different slot types is supported.

The plurality of slots for transmitting the PUSCH including the one transport block may include at least one of a slot where symbols allocated for the PUSCH transmission within each slot are set as non-subband full duplex (non-SBFD) symbols that are all uplink (UL) or flexible according to the TDD configuration information, not including SSB reception symbols, or a slot where the symbols are reset as SBFD symbols configured as downlink (DL) or flexible according to the TDD configuration information and in which an uplink subband is defined according to the subband configuration information.

In other words, the slots for transmitting one transport block should not include SSB reception symbols among the symbols allocated for PUSCH transmission within a slot. The slots may be configured to include either only non-SBFD slots, only SBFD slots, or both. Here, an SBFD slot and a non-SBFD slot each represent a slot type.

Therefore, the UE may determine the slots according to whether the slots include both SBFD slots (composed of SBFD symbols) and non-SBFD slots (composed of non-SBFD symbols) based on the configuration by the base station. To that end, the UE may receive enable/disable information for PUSCH transmission (TBoMS) across different slot types explicitly or implicitly from the base station.

The UE may be explicitly configured to activate PUSCH transmission according to TBoMS through different slot types from the base station through cell-specific or UE-specific RRC signaling. Alternatively, the UE may be explicitly instructed to active PUSCH transmission (TBoMS) across different slot types via a DCI format or an uplink grant of RAR. Alternatively, activation of PUSCH transmission (TBoMS) across different slot types may be implicitly configured by FDRA information for PUSCH transmission or type information of the first PUSCH transmission slot, information of DCI format reception slot type including PUSCH scheduling control information, etc. Alternatively, it may be configured as a combination of the above-described explicit configuration and implicit configuration.

When PUSCH transmission according to TBoMS across different slot types is activated, the UE may include both non-SBFD slots and SBFD slots when counting the plurality of slots capable of PUSCH transmission. However, the UE may determine the plurality of slots excluding only slot in which the symbols allocated for PUSCH transmission include SBFD symbols configured or indicated by the base station for downlink reception.

In other words, SBFD symbols within an SBFD slot include both an uplink subband and a downlink subband based on the TDD configuration information and the subband configuration information, and the base station may configure or indicate a transmission direction of SBFD symbols as UL or DL. Therefore, when at least one SBFD symbol allocated for PUSCH transmission within an SBFD slot is configured or indicated by the base station for downlink transmission, a slot including the corresponding symbol may be excluded from counting the plurality of slots. This may equally apply when PUSCH transmission according to TBoMS across different slot types is deactivated and configured as an SBFD slot type for PUSCH transmission (TBoMS).

Hereinafter, when PUSCH transmission (TBoMS) across different slot types is activated, a specific example of determining a plurality of slots used for PUSCH transmission according to TBoMS is described.

According to an embodiment, when supporting PUSCH transmission according to TBoMS in non-SBFD slots and SBFD slots according to explicit or implicit configuration, i.e., when implicitly or explicitly configured to include SBFD slots in determining the PUSCH transmission slots according to the TBoMS, the PUSCH transmission slots according to TBoMS at the corresponding UE may be determined as follows.

When explicitly or implicitly configured to include SBFD slots in addition to non-SBFD slots in PUSCH transmission slots according to TBoMS, the UE may count N·K slots according to the number N of slots for transmission of one transport block, excluding slots satisfying the following conditions, when determining PUSCH transmission slots according to TBoMS scheduled by DCI format 0_1 or DCI format 0_2. Here, K may be the PUSCH repetition count according to a pusch-AggregationFactor configuration value for the PUSCH repetition when PUSCH repetition is configured, or when TDRA configuration and indication including numberOfRepetitions is made. N and K may be used identically hereinafter.

In this case, for each slot, when at least one symbol among symbols according to the time domain resource allocation information for PUSCH transmission according to the corresponding TBoMS is a non-SBFD symbol and indicated as a DL symbol by the TDD configuration information, the corresponding slot may be excluded from counting. Further, for each slot, when at least one symbol among symbols according to the time domain resource allocation information for PUSCH transmission according to the corresponding TBoMS is an SBFD symbol and indicated as a DL symbol, the corresponding slot may be excluded from counting. Further, for each slot, when at least one symbol among symbols according to the time domain resource allocation information for PUSCH transmission according to the corresponding TBoMS includes an SS/PBCH block by SSB-PositionInBurst, the corresponding slot may be excluded from slot counting. Alternatively, for each slot, when at least one symbol among symbols according to the time domain resource allocation information for PUSCH transmission according to TBoMS is an SBFD symbol indicated as a UL symbol, but the corresponding symbol is configured or indicated by the base station to fallback to a DL symbol that is a legacy TDD configuration, the corresponding slot may be excluded from slot counting. In other cases, the UE may configure consecutive N. K slots as PUSCH transmission slots according to TBoMS.

According to another embodiment, when PUSCH transmission according to TBoMS through different slot types is deactivated, the UE may determine the plurality of slots according to only one slot type, either slots including SBFD symbols or slots including non-SBFD symbols. In other words, the plurality of slots used for PUSCH transmission according to TBoMS may be counted only as SBFD slots or only as non-SBFD slots.

In this case, the slot type for determining the plurality of slots used for PUSCH transmission according to TBoMS may be configured or indicated by the base station, determined by the type of symbol where the downlink control information including the scheduling information of PUSCH was received, or determined by the symbol type of the first slot among the plurality of slots. In other words, when PUSCH transmission according to TBoMS through different slot types is deactivated, the slot type in which PUSCH transmission according to TBoMS is performed may be determined by the reception slot type of the DCI format including the scheduling control information for the corresponding PUSCH, or may be determined by the first PUSCH transmission slot type by the DCI format. Alternatively, slot type configuration information or indication information for PUSCH transmission according to TBoMS may be transmitted by the base station through RRC signaling or through the corresponding DCI format.

Hereinafter, when PUSCH transmission (TBoMS) across different slot types is deactivated and the slot type used for PUSCH transmission (TBoMS) is configured or indicated as a non-SBFD slot, a specific example of determining a plurality of slots for PUSCH transmission according to TBoMS is described.

When the UE is explicitly or implicitly configured not to include SBFD slots in the PUSCH transmission slots for TBoMS, the UE may count N·K slots except for slots satisfying the following conditions when determining PUSCH transmission slots according to TBoMS scheduled by DCI format 0_1 or DCI format 0_2.

In this case, for each slot, when at least one symbol among symbols according to the time domain resource allocation information for PUSCH transmission according to the corresponding TBoMS is indicated as a DL symbol by the TDD configuration information, the corresponding slot may be excluded from counting. Further, for each slot, when at least one symbol among symbols according to the time domain resource allocation information for PUSCH transmission under the corresponding TBoMS is indicated as an SS/PBCH block symbol based on index information of ssb-PositionsInBurst, the corresponding slot may be excluded from counting.

Hereinafter, when PUSCH transmission according to TBoMS through different slot types is deactivated and the slot type used for PUSCH transmission according to TBoMS is configured or indicated as an SBFD slot, a specific example of determining a plurality of slots used for PUSCH transmission according to TBoMS is described.

When explicitly or implicitly configured to include only SBFD slots in the PUSCH transmission slots for TBoMS, the UE may count N·K slots except for slots satisfying the following conditions when determining PUSCH transmission slots according to TBoMS scheduled by DCI format 0_1 or DCI format 0_2.

In this case, for each slot, when at least one symbol among symbols according to the time domain resource allocation information for PUSCH transmission according to the corresponding TBoMS is a non-SBFD symbol, the corresponding slot may be excluded from counting. Further, for each slot, when at least one symbol among symbols according to the time domain resource allocation information for PUSCH transmission according to the corresponding TBoMS is an SBFD symbol and indicated as a DL symbol, the corresponding slot may be excluded from counting. Further, for each slot, when at least one symbol among symbols according to the time domain resource allocation information for PUSCH transmission according to the corresponding TBoMS is indicated as an SS/PBCH block symbol by index information of ssb-PositionsInBurst, the corresponding slot may be excluded from counting. Further, for each slot, when at least one symbol among symbols according to the time domain resource allocation information for PUSCH transmission according to the corresponding TBoMS is a symbol configured or indicated by the base station to fallback to a legacy TDD configuration, the corresponding slot may be excluded from counting.

According to an embodiment, when a plurality of slots for PUSCH transmission according to TBoMS includes both slots including SBFD symbols and slots including non-SBFD symbols, the UE may transmit PUSCH according to separately defined downlink control information for PUSCH transmission according to TBoMS.

In other words, when PUSCH transmission according to TBoMS is configured for the UE and PUSCH transmission according to TBoMS through different slot types is explicitly or implicitly activated by the base station, a separate DCI format, e.g., DCI format 0_x, may be newly defined for this. When a DCI format is separately defined, the information field of the corresponding DCI format may be configured by being divided into a slot type common information area and a slot type specific information area.

In this case, the slot type common information area may be an information area configured and applied identically to PUSCH transmission in non-SBFD slots and PUSCH transmission in SBFD slots. Therefore, it may have one configuration value within the corresponding DCI format. For example, a TDRA information area, etc. may be a slot type common information area and may include a single information area as before.

On the other hand, the slot type specific information area may be an information area separately configured and applied for PUSCH transmission in non-SBFD slots and PUSCH transmission in SBFD slots. Therefore, the same information area may have a configuration value for non-SBFD slots and a separate configuration value for SBFD slots, respectively. For example, FDRA, TCI field, etc. may be slot type specific information areas.

However, the content is an example, and all combinations in which predetermined information areas are applied commonly to slot types through configuration values while other information areas are configured separately for each slot type when configuring DCI format 0_x may be included in the disclosure.

After determining the plurality of slots for PUSCH transmission according to TBoMS, the UE may transmit the PUSCH according to TBoMS to the base station through at least some slots among the determined plurality of slots. In other words, the UE may determine a plurality of slots available for PUSCH transmission according to TBoMS and transmit the PUSCH using all or some of those slots depending on the circumstance configured for the UE. For example, in circumstances where higher priority PUCCH transmission is configured, PUSCH transmission may be dropped for slots allocated for PUCCH transmission among the determined slots.

According to the embodiments described above, an uplink data channel may be efficiently transmitted and received within slots or symbols where full duplex communication is applied.

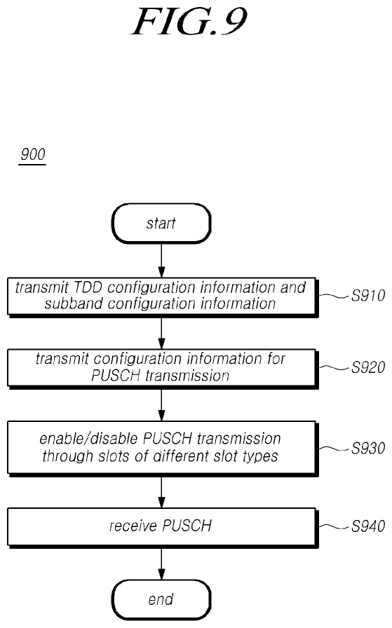

FIG. 9 is a flowchart illustrating a method 900 for a base station receiving an uplink data channel according to an embodiment. The description described above in FIG. 8 may be omitted to avoid redundant description, and the omitted content may still be substantially applied to the base station, provided that it does not conflict with the technical spirit of the disclosure.

Referring to FIG. 9, the base station may transmit time division duplex (TDD) configuration information and subband configuration information (S910).

Time division duplex (TDD) is a method of using time-domain radio resources by dividing them into downlink slots and uplink slots, and the base station may transmit TDD configuration information to the UE to determine the format of symbols within a slot. In this case, the TDD configuration information may include configuration information about the format of the slot and configuration information for determining the symbol format within the slot, and the corresponding information may be received through higher layer signaling or physical layer L1 signaling.

In other words, a downlink symbol, an uplink symbol, and a flexible symbol of a predetermined period in which the transmission direction is not determined may be configured through an RRC message for configuring a corresponding UL-DL slot. Further, the base station may transmit UE-specific RRC signaling that reallocates flexible symbols among those configured through cell-specific RRC signaling to uplink symbols, downlink symbols, or flexible symbols for each UE.

Alternatively, the base station may indicate a dynamic slot format through a UE-group common PDCCH. According to an embodiment, the base station may dynamically indicate the slot format through DCI format 2_0.

The base station may transmit subband configuration information for full-duplex communication to the UE. In other words, the base station may transmit configuration information for configuring a downlink subband in an uplink slot or an uplink subband in a downlink slot. The subband configuration information may include time-domain information and frequency-domain information where an uplink subband or a downlink subband is configured. Alternatively, the subband configuration information may include frequency-domain information and time-domain information where a guard band is configured.

The subband configuration information may be transmitted through a broadcasting scheme transmitted to all the UEs in the cell. Alternatively, it may be transmitted through a multi-casting scheme that transmits to UEs requiring a full-duplex communication mode operation or a unicasting scheme that transmits only to a specific UE. The base station may transmit the corresponding configuration information according to the configured method.

In other words, a downlink slot or a downlink symbol configured for the UE may include an SBFD symbol in which an uplink subband is configured for full-duplex communication. In other words, an uplink subband may be configured for at least some of the downlink slots or downlink symbols configured for the UE, and in this case, an uplink subband, a downlink subband, and/or a guardband may be configured for the corresponding slot or symbol.

Similarly, an uplink slot or an uplink symbol configured for the UE may include an SBFD symbol in which a downlink subband is configured for full-duplex communication. That is, a downlink subband may be configured for at least some of the uplink slots or uplink symbols configured for the UE, and in this case, an uplink subband, a downlink subband, and/or a guardband may be configured for the corresponding slot or symbol.

Referring back to FIG. 9, the base station may transmit PUSCH configuration information that includes slot number configuration information for PUSCH transmission, including one transport block (TB) (S920).

The base station may transmit to the UE the PUSCH configuration information for configuring or indicating transmission of one transport block across a plurality of slots. That is, the base station may configure or indicate TB processing over multiple slots (TBoMS) for PUSCH transmission. To that end, an information element configured in RRC, e.g., PUSCH-TimeDomainResourceAllocationList, may include time domain allocation configuration information areas.

In this case, the time domain allocation configuration information may include configuration information indicating the numbers of slots across which a single transport block is transmitted. According to an embodiment, the number of the slots may be configured as 1 (in case of typical single slot processing), 2, 4, or 8 consecutive slots.

Referring back to FIG. 9, the base station may configure whether to enable PUSCH transmission including one transport block through slots of different slot types (S930). The base station may receive the PUSCH including the one transport block through a plurality of slots determined based on whether PUSCH transmission including the one transport block is enabled (S940).

The base station may indicate through a time domain resource assignment (TDRA) indication information area (e.g., information field) of a downlink control information (DCI) format, i.e., an uplink grant (UL grant), that one transport block transmitted through the corresponding PUSCH transmission is to be transmitted across a plurality of slots for PUSCH transmission of the UE. In other words, one time domain allocation configuration information among the time domain allocation configuration information areas belonging to the above-described PUSCH-TimeDomainResourceAllocationList may be indicated through the time domain resource allocation indication information area. In this case, when the corresponding time domain allocation information includes information (e.g., information field) indicating the number of slots across which one transport block is transmitted, it may be configured and indicated that the corresponding one transport block, i.e., the corresponding PUSCH transmission, is performed through consecutive slots corresponding to one of 1, 2, 4, or 8 according to the configuration value of the information about the number of the plurality of slots.

As such, when one PUSCH transmission is performed through a plurality of slots through TBoMS configuration or indication, slots configured or indicated for uplink transmission at the UE may belong to different slot types. For example, assume a case where PUSCH transmission is configured or indicated to be performed across 8 consecutive slots for TBoMS. When 8 slots configured or indicated to enable uplink transmission at the UE from the slot where PUSCH transmission starts include both SBFD slots and non-SBFD slots, a plurality of slots in which one transport block is transmitted may be determined according to whether PUSCH transmission across different slot types is supported.

The plurality of slots for transmitting the PUSCH including the one transport block may include at least one of: i) a slot in which symbols allocated for the PUSCH transmission within each slot, excluding SSB reception symbols, are set as non-subband full duplex (non-SBFD) symbols configured as uplink (UL) or flexible symbols according to the TDD configuration information; or ii) a slot in which the symbols are reset as SBFD symbols configured as downlink (DL) or flexible according to the TDD configuration information and in which an uplink subband is configured according to the subband configuration information.

In other words, the plurality of slots to be used for transmitting one transport block should not include SSB reception symbols among symbols allocated for PUSCH transmission within a slot and may be configured to include either only non-SBFD slots, only SBFD slots, or both. Here, an SBFD slot and a non-SBFD slot each represent a slot type.

Therefore, the UE may determine the plurality of slots according to whether the plurality of slots includes both SBFD slots (composed of SBFD symbols) and non-SBFD slots (composed of non-SBFD symbols), based on the configuration by the base station. To that end, the base station may transmit enable/disable information for PUSCH transmission according to TBoMS across different slot types explicitly or implicitly to the UE.

The base station may explicitly configure activation of PUSCH transmission according to TBoMS across different slot types to the UE via cell-specific or UE-specific RRC signaling. Alternatively, the base station may explicitly instruct activation of PUSCH transmission according to TBoMS across different slot types via a DCI format or an uplink grant of RAR. Alternatively, activation of PUSCH transmission according to TBoMS across different slot types may be implicitly configured by FDRA information for PUSCH transmission or type information of the first PUSCH transmission slot, information of DCI format reception slot type including PUSCH scheduling control information, etc. Alternatively, it may be configured as a combination of the above-described explicit configuration and implicit configuration.

When PUSCH transmission according to TBoMS across different slot types is activated, the UE may include both non-SBFD slots and SBFD slots when counting the plurality of slots capable of PUSCH transmission. However, the UE may determine the plurality of slots excluding any slot in which the symbols allocated for PUSCH transmission include SBFD symbols configured or indicated by the base station for downlink reception.

In other words, SBFD symbols within an SBFD slot include both an uplink subband and a downlink subband based on the TDD configuration information and the subband configuration information, and the base station may configure or indicate the transmission direction of SBFD symbols as UL or DL. Therefore, when at least one SBFD symbol allocated for PUSCH transmission within an SBFD slot is configured or indicated by the base station for downlink (DL) transmission, a slot including the corresponding symbol may be excluded from counting the plurality of slots. This may equally apply when PUSCH transmission according to TBoMS across different slot types is deactivated and configured as an SBFD slot type for PUSCH transmission according to TBoMS.

Hereinafter, when PUSCH transmission according to TBoMS through different slot types is activated, a specific example of determining a plurality of slots used for PUSCH transmission according to TBoMS is described.

According to an embodiment, when supporting PUSCH transmission according to TBoMS in non-SBFD slots and SBFD slots according to explicit or implicit configuration, i.e., when the UE is implicitly or explicitly configured to include SBFD slots in determining the PUSCH transmission slots according to the TBoMS, the PUSCH transmission slots according to TBoMS at the corresponding UE may be determined as follows.

When the UE is explicitly or implicitly configured to include SBFD slots in addition to non-SBFD slots in PUSCH transmission slots according to TBoMS, the UE may count N·K slots according to the number N of slots for transmission of one transport block, excluding slots satisfying the following conditions, when determining PUSCH transmission slots according to TBoMS scheduled by DCI format 0_1 or DCI format 0_2. Here, K may represent the PUSCH repetition count according to a pusch-AggregationFactor configuration value for the PUSCH repetition when PUSCH repetition is configured, or according to a TDRA configuration and indication including numberOfRepetitions.

In this case, for each slot, when at least one symbol among symbols according to the time domain resource allocation information for PUSCH transmission according to the corresponding TBoMS is a non-SBFD symbol and indicated as a DL symbol by the TDD configuration information, the corresponding slot may be excluded from counting. Further, for each slot, when at least one symbol among symbols according to the time domain resource allocation information for PUSCH transmission according to the corresponding TBoMS is an SBFD symbol and indicated as a DL symbol, the corresponding slot may be excluded from counting. Further, for each slot, when at least one symbol among symbols according to the time domain resource allocation information for PUSCH transmission according to the corresponding TBoMS includes an SS/PBCH block by SSB-PositionInBurst, the corresponding slot may be excluded from slot counting. Alternatively, for each slot, when at least one symbol among symbols according to the time domain resource allocation information for PUSCH transmission according to TBoMS is an SBFD symbol indicated as a UL symbol, but the corresponding symbol is configured or indicated by the base station to fallback to a DL symbol that is a legacy TDD configuration, the corresponding slot may be excluded from slot counting. In other cases, the UE may configure consecutive N. K slots as PUSCH transmission slots according to TBoMS.

According to another embodiment, when PUSCH transmission according to TBoMS across different slot types is deactivated, the UE may determine the plurality of slots according to only one slot type, either slots including SBFD symbols or slots including non-SBFD symbols. In other words, the plurality of slots used for PUSCH transmission according to TBoMS may be counted only as SBFD slots or only as non-SBFD slots.

In this case, the slot type for determining the plurality of slots used for PUSCH transmission according to TBoMS may be configured or indicated by the base station, determined by the type of symbol where the downlink control information including the scheduling information of PUSCH was received, or determined by the symbol type of the first slot among the plurality of slots. In other words, when PUSCH transmission according to TBoMS across different slot types is deactivated, the slot type in which PUSCH transmission according to TBoMS is performed may be determined by the reception slot type of the DCI format including the scheduling control information for the corresponding PUSCH, or may be determined by the first PUSCH transmission slot type by the DCI format. Alternatively, the base station may transmit slot type configuration information or indication information for PUSCH transmission according to TBoMS through RRC signaling or through the corresponding DCI format.

Hereinafter, when PUSCH transmission according to TBoMS across different slot types is deactivated and the slot type used for PUSCH transmission according to TBoMS is configured or indicated as a non-SBFD slot, a specific example of determining a plurality of slots used for PUSCH transmission according to TBoMS is described.

When the UE is explicitly or implicitly configured not to include SBFD slots in the PUSCH transmission slots for TBoMS, the UE may count N·K slots except for slots satisfying the following conditions when determining PUSCH transmission slots according to TBoMS scheduled by DCI format 0_1 or DCI format 0_2.

In this case, for each slot, when at least one symbol among symbols according to the time domain resource allocation information for PUSCH transmission according to the corresponding TBoMS is indicated as a DL symbol by the TDD configuration information, the corresponding slot may be excluded from counting. Further, for each slot, when at least one symbol among symbols according to the time domain resource allocation information for PUSCH transmission according to the corresponding TBoMS is indicated as an SS/PBCH block symbol by index information of ssb-PositionsInBurst, the corresponding slot may be excluded from counting.

Hereinafter, when PUSCH transmission according to TBoMS across different slot types is deactivated and the slot type used for PUSCH transmission according to TBoMS is configured or indicated as an SBFD slot, a specific example of determining a plurality of slots used for PUSCH transmission according to TBoMS is described.

When explicitly or implicitly configured to include only SBFD slots in the PUSCH transmission slots for TBoMS, the UE may count N·K slots except for slots satisfying the following conditions when determining PUSCH transmission slots according to TBoMS scheduled by DCI format 0_1 or DCI format 0_2.

In this case, for each slot, when at least one symbol among the symbols according to the time domain resource allocation information for PUSCH transmission according to the corresponding TBoMS is a non-SBFD symbol, the corresponding slot may be excluded from counting. Further, for each slot, when at least one symbol among the symbols according to the time domain resource allocation information for PUSCH transmission under the corresponding TBoMS is an SBFD symbol that is indicated as a DL symbol, the corresponding slot may be excluded from counting. Further, for each slot, when at least one symbol among the symbols according to the time domain resource allocation information for PUSCH transmission under the corresponding TBoMS is indicated as an SS/PBCH block symbol based on index information of ssb-PositionsInBurst, the corresponding slot may be excluded from counting. Further, for each slot, when at least one symbol among the symbols according to the time domain resource allocation information for PUSCH transmission under the corresponding TBoMS is a symbol configured or indicated by the base station to fall back to a DL symbol according to a legacy TDD configuration, the corresponding slot may be excluded from counting.

According to an embodiment, when a plurality of slots for PUSCH transmission according to TBoMS includes both slots including SBFD symbols and slots with non-SBFD symbols, the base station may receive PUSCH according to separately defined downlink control information for PUSCH transmission according to TBoMS.

In other words, when PUSCH transmission according to TBoMS is configured for the UE and PUSCH transmission according to TBoMS across different slot types is explicitly or implicitly activated by the base station, a separate DCI format, for example, DCI format 0_x, may be newly defined for this. When a DCI format is separately defined, the information field of the corresponding DCI format may be configured to include a slot type common information area and a slot type specific information area.

In this case, the slot type common information area may be an information area configured and applied identically to PUSCH transmission in non-SBFD slots and PUSCH transmission in SBFD slots. Therefore, it may have one configuration value within the corresponding DCI format. For example, a TDRA information area may be a slot type common information area and may include a single information area as before.

On the other hand, the slot type specific information area may be an information area separately configured and applied for PUSCH transmission in non-SBFD slots and PUSCH transmission in SBFD slots. Therefore, the same information area may have a configuration value for non-SBFD slots and a separate configuration value for SBFD slots, respectively. For example, FDRA, TCI field, etc. may be slot type specific information areas.

However, the content is provided as an example, and all combinations in which predetermined information areas are applied commonly to slot types through configuration values while other information areas are separately configured for each slot type when configuring DCI format 0_x may be included in the disclosure.

After the UE determines the plurality of slots for PUSCH transmission according to TBoMS, the base station may receive the PUSCH according to TBoMS through at least some slots among the determined plurality of slots. In other words, the UE determines a plurality of slots available for PUSCH transmission according to TBoMS and transmit PUSCH using all or some of the corresponding plurality of slots according to the circumstance configured for the UE. For example, in circumstances where higher priority PUCCH transmission is configured, PUSCH transmission may be dropped for slots allocated for PUCCH transmission among the determined slots.

According to the embodiments described above, an uplink data channel may be efficiently transmitted and received within slots or symbols where full duplex communication is applied.

Hereinafter, with reference to the accompanying drawings, each embodiment related to a method for transmitting/receiving an uplink data channel in full duplex communication will be specifically described.

The disclosure proposes a resource allocation method for uplink data channel transmission of a UE, i.e., PUSCH transmission, in any base station/cell in which uplink subband (UL subband) or downlink subband (DL subband) configuration for supporting full duplex communication in a wireless mobile communication system is configured. In particular, when any PUSCH transmission is indicated to be transmitted through a plurality of slots according to ‘transport block (TB) processing over multiple slots’ configuration or indication, a method for supporting the corresponding PUSCH transmission through SBFD slots including UL subband and non-SBFD slots (e.g., conventional UL slots) is proposed.

Time division duplex (TDD) is a duplexing method widely used in commercial new radio (NR), i.e., 5G mobile communication systems. In TDD, time-domain radio resources are divided into downlink slots and uplink slots, and downlink slots are usually distributed at a higher ratio than uplink slots according to the distribution ratio of uplink traffic and downlink traffic. However, this limitation of the uplink slot negatively affects coverage and latency. Full-duplex communication may be applied as a technology for addressing such issues.

Specifically, full-duplex communication is a technique in which a gNB, i.e., a base station, simultaneously performs DL transmission and UL reception in the same radio resource. The UE side may simultaneously perform DL reception and UL transmission as well. In other words, both the base station and the UE may support full duplex. However, unlike the base station, for which self-interference cancellation is structurally easy, in the UE, DL reception performance is prone to be affected by self-interference of UL transmission signals. Therefore, it is generally considered that the base station operates in full-duplex communication, and the UE operates in half-duplex communication. Further, a subband non-overlapping full duplex method in order to reduce the influence of self-interference, the base station simultaneously performs DL transmission and UL reception but performs transmission and reception with frequency resources discerned, rather than using the same resource may be primarily considered.

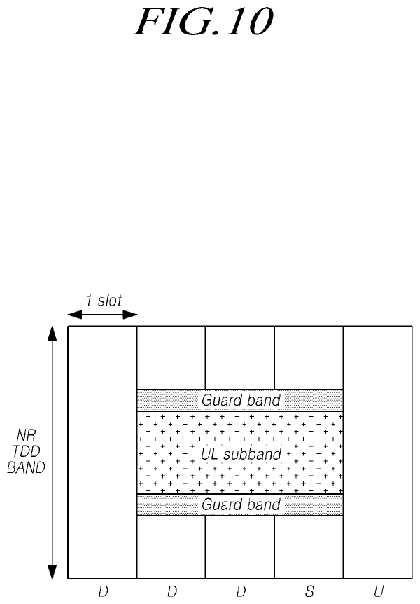

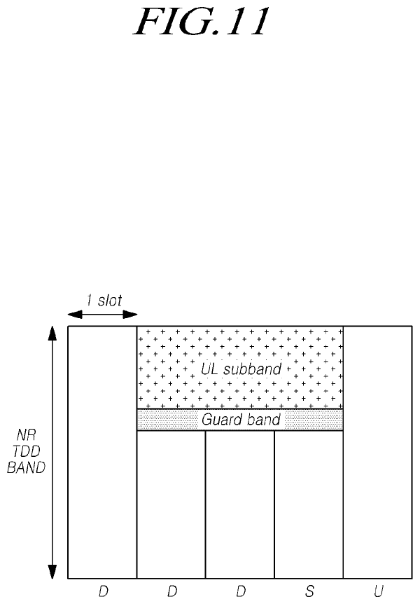

In other words, FIGS. 10 and 11 illustrate an example in which DL slots and UL slots are configured in a ratio of 4:1 in any NR frequency band. However, some symbols of the last DL slot may be a special slot including a flexible symbol for DL/UL transition. As described above, when a time division duplex (TDD) configuration is implemented, an uplink subband for supporting UL transmission of the UE may be configured in some (or all) DL slots of the corresponding DL slots. When the UL subband is set in any DL slot, the UL subband may be configured in the center of the corresponding frequency band as shown in FIG. 10 or may be configured at the edge of the corresponding frequency band as shown in FIG. 11. In this case, a guard band may be configured between the UL subband and the downlink subband (DL subband) in the corresponding slot.

The disclosure proposes a method for BWP configuration when an arbitrary base station/network supports sub band non-overlapping full duplex, and accordingly, a method for transmitting/receiving uplink/downlink wireless signals (DM-RS, CSI-RS, SRS, PSS/SSS, etc.) and wireless channels (e.g., PDCCH/PDSCH and PUSCH/PUCCH, etc.) between the base station and the UE. However, the description of the disclosure may be substantially identically applied to other various full-duplex application scenarios. For example, the full duplex application scenario may include a full duplex operation in an unpaired spectrum and a full duplex operation in a downlink (DL) frequency band or an uplink (UL) frequency band of a paired spectrum. Further, as described above, the description of the disclosure may be substantially identically applied to a scenario in which subband non-overlapping full duplex or pure full duplex (i.e., DL transmission and UL reception simultaneously in the same frequency resource) is supported only on the base station side, and a half duplex operation is performed in the UE. Further, the description of the disclosure may be substantially identically applied even when not only the base station but also the UE supports subband non-overlapping full duplex or pure full duplex.

The uplink-downlink (UL-DL) slot configuration defined in NR is defined to be performed in units of cells through cell-specific RRC signaling. In other words, patterns of DL symbols, UL symbols, and flexible symbols of a predetermined period are configured through the RRC message ‘tdd-UL-DL-ConfigurationCommon’ for the corresponding UL-DL slot configuration. Additionally, through ‘tdd-UL-DL-ConfigurationDedicated’ which is UE-specific RRC signaling, only flexible symbols configured through the ‘tdd-UL-DL-ConfigurationCommon’ may be reallocated as UL symbols, DL symbols, or flexible symbols for each UE. Or, a method for indicating a dynamic slot format through a UE-group common PDCCH has also been defined. To that end, NR also supports a slot format indication method in a dynamic form through DCI format 2_0.

According to the above-described slot configuration method, any one symbol may be configured or indicated as one of DL, UL, or Flexible. FIG. 10 illustrates an example in which any slot format is set as DDDSU through the conventional slot configuration. D is a down link slot, which means that all OFDM symbols constituting the corresponding slot are set as DL. U is an uplink slot, which means that all OFDM symbols constituting the corresponding slot are set as UL. S is a special slot, which means a slot including a flexible symbol for DL/UL transition. In general, the special slot may be composed of 12 DL symbols and 2 flexible symbols out of a total of 14 symbols for a normal CP. Alternatively, it may be composed of 10 DL symbols, 2 flexible symbols, and 2 UL symbols. In other words, within any one TDD carrier, one symbol was set or indicated as only one of DL, UL, or flexible.

However, when the UL subband is configured in any DL slot as shown in FIGS. 10 and 11, DL transmission or UL transmission may occur simultaneously for each frequency resource in the corresponding symbol. As described above, a DL slot or symbol including a UL subband or a UL slot or symbol including a DL subband will be referred to as an SBFD slot or an SBFD symbol in the disclosure.

Further, in the disclosure, a slot composed of only SBFD symbols is referred to as an SBFD slot, and a slot composed of only symbols according to the typical symbol configuration (i.e., a slot composed of only symbols not including a UL subband, a DL subband, and a guardband) is referred to as a non-SBFD slot. Alternatively, a slot including at least one SBFD symbol may be referred to as an SBFD slot.

Alternatively, for any UE, an SBFD slot may mean, as described above, a slot in which all symbols are SBFD symbols and fallback is not indicated by the base station with legacy slot configuration.

Alternatively, for any UE, an SBFD slot may mean, as described above, a slot in which all symbols are SBFD symbols and the UE is explicitly configured or indicated by the base station to perform UL transmission operations in the corresponding SBFD symbols.

Alternatively, for any UE, an SBFD slot may mean, as described above, a slot in which all symbols are SBFD symbols and the UE is not explicitly configured or indicated by the base station to perform DL reception operations in the corresponding SBFD symbols.

Alternatively, for any UE, an SBFD slot may mean, as described above, a slot in which all symbols are SBFD symbols, the UE is explicitly configured or indicated by the base station to perform UL transmission operations in the corresponding SBFD symbols, and fallback is not indicated by the base station with legacy slot configuration.

Alternatively, for any UE, an SBFD slot may mean, as described above, a slot in which all symbols are SBFD symbols, the UE is not explicitly configured or indicated by the base station to perform DL reception operations in the corresponding SBFD symbols, and fallback is not indicated by the base station with legacy slot configuration.

However, in the disclosure, legacy slot configuration or legacy TDD configuration may refer to a configuration in which a pattern of DL symbols, UL symbols, and flexible symbols with a predetermined period is set through the typical RRC message ‘tdd-UL-DL-ConfigurationCommon’. Further, it may refer to a UL-DL configuration according to UE-specific RRC signaling ‘tdd-UL-DL-ConfigurationDedicated’. Alternatively, it may refer to a dynamic type slot format indication through DCI format 2_0.

According to the PUSCH transmission method of a UE defined in existing 5G NR, any UE supports dynamic scheduling-based PUSCH transmission through UL grant of downlink control information (DCI) transmitted through PDCCH by the base station and configured grant-based PUSCH transmission based on RRC configuration. In particular, configured grant-based PUSCH transmission includes configured grant type 1 by higher layer parameter ‘configuredGrantConfig’ including ‘rrc-ConfiguredUplinkGrant’ without activation through separate DCI, and configured grant type 2 that is activated through DCI according to the semi-persistent scheduling method of existing LTE.

The dynamic scheduling-based PUSCH transmission involves DCI format transmission (e.g., DCI format 0_0, 0_1, 0_2, etc.) for resource allocation per PUSCH transmission on a slot basis or sub slot basis, and PUSCH transmission is performed based on resource allocation information included in the corresponding DCI format. Therefore, PUSCH transmission resource allocation in SBFD slots composed of SBFD symbols as described above and PUSCH transmission resource allocation in non-SBFD slots such as UL slots may be performed through separate DCI transmissions.

However, in the case of predetermined dynamic scheduling-based PUSCH transmissions, PUSCH transmission in different types of slots may be triggered through one DCI. For example, when PUSCH repetition is configured/indicated, when TB processing over multiple slots (TBoMS) is configured/indicated, or when scheduling for multiple PUSCH transmissions is performed through one DCI may be included.

In the disclosure, when any PUSCH transmission that is dynamically scheduled through one DCI is indicated to be performed through one or more slots, particularly when TB processing over multiple slots is configured/indicated, a specific method for supporting the corresponding PUSCH transmission to be performed across different types of slots, i.e., including SBFD slots and non-SBFD slots, is proposed.

In the disclosure, the term ‘slot type’ is used to distinguish between SBFD slots and non-SBFD slots, but the invention is not limited by specific names.

The base station may indicate through a time domain resource assignment (TDRA) indication information area (e.g., information field) of a DCI format, i.e., an uplink grant (UL grant), that one TB (transport block) transmitted through the corresponding PUSCH transmission is transmitted across a plurality of slots for PUSCH transmission for any UE. In other words, one time domain allocation configuration information among the time domain allocation configuration information areas belonging to RRC configured PUSCH-TimeDomainResourceAllocationList is indicated through the corresponding time domain resource assignment indication information area. In this case, when the corresponding time domain allocation information includes numberOfSlotsTBoMS, it may be configured and indicated that the corresponding one TB, i.e., the corresponding PUSCH transmission, is performed through 1 (conventional single slot processing), 2, 4, or 8 consecutive slots according to the corresponding numberOfSlotsTBoMS configuration value.

As such, when one PUSCH transmission is performed through a plurality of slots through any ‘TB processing over multiple slots configuration/indication, slots configured/indicated for UL transmission at the corresponding UE may belong to the different slot types mentioned above. For example, when PUSCH transmission is configured/indicated to be performed across eight consecutive slots for ‘TB processing over multiple slots’, and 8 slots configured or indicated to enable UL transmission at the corresponding UE from the slot where the corresponding PUSCH transmission starts include both the SBFD slots and non-SBFD slots mentioned above, it is necessary to specifically define whether to support PUSCH transmission across the corresponding different slot types.

As described above, the base station may configure a time domain resource allocation table for indicating PUSCH transmission time resource allocation information of any UE through RRC signaling, and the corresponding TDRA table configuration information may additionally include the above-described numberOfSlotsTBoMS, N, along with K value and SLIV (start and length indication value) information. As such, when numberOfSlotsTBoMS configuration is made for any UE through TDRA table configuration information, the corresponding UE determines PUSCH transmission slots according to the corresponding TBoMS according to the TDRA value of the UL grant indicated by the base station as follows.

When AvailableSlotCounting is enabled for the corresponding UE, the UE may count N·K slots according to numberOfSlotsTBoMS, N, except for slots satisfying the following conditions when determining PUSCH transmission slots for TB processing over multiple slots scheduled by DCI format 0_1 or DCI format 0_2. (Here, K is the pusch-AggregationFactor configuration value for the corresponding PUSCH repetition when PUSCH repetition is configured, or the PUSCH repetition count according to when TDRA configuration and indication including numberOfRepetitions is made.)

When at least one symbol among the symbols according to time domain resource allocation information for PUSCH transmission under the corresponding TBoMS in any slot is indicated as a DL symbol by tdd-UL-DL-ConfigurationCommon or tdd-UL-DL-ConfigurationDedicated

When at least one symbol among the symbols according to time domain resource allocation information for PUSCH transmission under the corresponding TBoMS in any slot is indicated as an SS/PBCH block symbol by index information of ssb-PositionsInBurst

As such, when slots for performing PUSCH transmission according to TB processing over multiple slots are determined according to the conditions, whether actual PUSCH transmission in the corresponding slot is additionally determined by the following conditions according to legacy slot configuration. (However, in the disclosure, the term legacy slot configuration may refer to slot configuration based on tdd-UL-DL-ConfigurationCommon or tdd-UL-DL-ConfigurationDedicated, and may also include a dynamic slot format configuration by DCI format 2_0 in addition to such legacy slot configurations.)

When at least one symbol among the symbols allocated for PUSCH transmission within any one of the N. K slots is indicated as DL by tdd-UL-DL-ConfigurationCommon or tdd-UL-DL-ConfigurationDedicated, PUSCH is not transmitted in the corresponding slot.

However, as described above, even for slots or symbols configured as downlink (DL) by legacy slot configuration in any slot, PUSCH transmission may be possible for the UE when UL subband configuration is performed by the base station (that is, when configured as SBFD slots or symbols).

Therefore, the disclosure proposes a method for determining PUSCH transmission slots for performing TB processing over multiple slots operation of a UE when SBFD slot configuration is made by a base station, and a method for PUSCH transmission of the UE in the determined slots.

The methods proposed below may be applied independently as individual methods or in combination with one or more other methods, and all such cases fall within the scope of the disclosure. Hereinafter, for convenience of description, ‘TB processing over multiple slots’ will be simply referred to as TBoMS.

### Embodiment 1. Method for Determining PUSCH Transmission Slots According to TBoMS

When TBoMS is configured/indicated for one PUSCH transmission allocated to any UE, in determining PUSCH transmission slots according to the corresponding TBoMS, it may be defined that the base station explicitly or implicitly configures whether there is any restriction according to the slot type

Hereinafter, explicit configuration/indication methods are described.

The base station may define an additional information area (e.g., additional information field) for determining PUSCH transmission slots according to PUSCH TBoMS, i.e., for the PUSCH TBoMS slot counting mentioned above and may further define whether PUSCH transmission for a given slot type is enabled based on the corresponding information area. For example, a new information area, availableSBFDslotcountingTBoMS (this name is an example and the disclosure is not limited thereto) may be defined. The corresponding information may be interpreted by the UE as a parameter for determining whether to treat a specific slot type as a slot capable of the PUSCH transmission according to TBoMS (i.e., whether to include in or exclude from the available slot counting capable of the TBoMS mentioned above) configured or indicated by the base station. For example, when the corresponding availableSBFDslotcountingTBoMS is configured or enabled, SBFD slots may be excluded from slots for the TBoMS. In this case, the UE may determine PUSCH transmission slots for the corresponding TBoMS based only on non-SBFD slots. Conversely, when availableSBFDslotcountingTBoMS is configured or enabled, SBFD slots may be included in slots for the corresponding TBoMS.

Alternatively, availableSBFDslotcountingTBoMS may be configuration information about whether PUSCH transmission according to TBoMS is performed across different slot types. In this case, the same slot type as the first slot where TBoMS-based PUSCH transmission by DCI format starts may be counted as a slot for PUSCH transmission. In this case, whether to include (or exclude) PUSCH transmission slots for slots of a type different from the TBoMS-based PUSCH transmission start slot type may be determined by the configuration and enable status of the corresponding availableSBFDslotcountingTBoMS. In other words, when the TBoMS start slot type is an SBFD slot, SBFD slots are included in PUSCH transmission slots according to TBoMS, but for non-SBFD slots, whether to include PUSCH transmission slots may be determined by the availableSBFDslotcountingTBoMS configuration and enable status. Conversely, when the PUSCH transmission start slot type according to TBoMS is a non-SBFD slot, non-SBFD slots are included in PUSCH transmission slots according to TBoMS, but for SBFD slots, whether to include PUSCH transmission slots may be determined by the availableSBFDslotcountingTBoMS configuration and enable status.

The new information area availableSBFDslotcountingTBoMS may be semi-statically configured by the base station and transmitted through UE-specific or cell-specific RRC signaling. In this case, the corresponding new RRC parameter, availableSBFDslotcountingTBoMS, may be included in an existing RRC message (e.g., PUSCH-config, etc.), or a new RRC message (e.g., UL subband configuration message, etc.) may be defined and included therein.

The new information area availableSBFDslotcountingTBoMS may be dynamically configured by the base station and transmitted to the UE through L1 control signaling. For example, the base station includes the corresponding indication information in DCI format for UL grant transmission (e.g., DCI format 0_0, 0_1, 0_2, etc.) or transmits the corresponding indication information through UE-group common DCI.

Further, various combinations of explicit signaling methods may be included in the disclosure. For example, whether to include an indication information area (e.g., indication information field) for the availableSBFDslotcountingTBoMS in a specific DCI format (e.g., DCI format 0_1, 0_2 for UL grant transmission or UE-group common DCI format, etc.) for the corresponding UE may be configured through RRC signaling for a UE. When configured to include the corresponding indication information area, it may be defined to dynamically indicate whether to include PUSCH transmission slots according to the TBoMS through the corresponding field.

Hereinafter, an implicit configuration/indication method is described.

In particular, the implicit configuration/indication method below may be applied as a method for determining whether to include the SBFD slots when determining slots for PUSCH transmission according to the TBoMS.

As an example of an implicit configuration method, it may be determined by whether there is overlap between frequency resources of an uplink bandwidth portion (UL BWP) activated for any UE and frequency resources of UL subband configured by the base station. In other words, whether to include SBFD slots when determining slots for PUSCH transmission according to TBoMS may be determined based on whether the corresponding active UL BWP and UL subband are fully overlapped, partially overlapped, or non-overlapped in the frequency axis. In this case, the target of overlap determination may be frequency resources of the active UL BWP. In other words, when the frequency resources of the UL BWP activated for any UE fully belong to the UL subband, the corresponding UE may be defined to include the SBFD slots when determining PUSCH transmission slots according to TBoMS. On the other hand, in case of partial overlap or non-overlap, the corresponding UE may not include the SBFD slots when determining PUSCH transmission slots according to TBoMS.

Alternatively, the target of the corresponding frequency resource overlap determination may be UL subband. In other words, when the frequency resources of the UL subband fully belong to the activated UL BWP for any UE, the corresponding UE may be defined to include SBFD slots when determining PUSCH transmission slots according to TBoMS. On the other hand, in case of partial overlap or non-overlap, the SBFD slots may not be included when determining PUSCH transmission slots according to TBoMS.

As another method, it may be implicitly determined by whether frequency resources allocated by the frequency domain resource assignment (FDRA) information area included in the UL grant, i.e., DCI format, for any PUSCH transmission are included in UL subband. For example, when the frequency resources according to the frequency domain resource assignment information for PUSCH transmission according to TBoMS fully belong to the UL subband, the corresponding UE may be defined to include SBFD slots when determining PUSCH transmission slots according to TBoMS. However, when intra-slot or inter-slot frequency hopping is configured, it may be limited to cases where frequency resources of each frequency hop all belong to UL subband, or the present method may be limited to apply only to cases where frequency hopping is not configured.

As another method, whether to include SBFD slots may be determined based on the slot type of the first slot where PUSCH transmission according to the corresponding TBoMS starts. As an example, when TBoMS is configured/indicated for any PUSCH transmission and the slot where the corresponding PUSCH transmission starts according to time domain resource assignment information is an SBFD slot, the corresponding UE may be defined to include SBFD slots when determining PUSCH transmission slots according to TBoMS. On the other hand, in the opposite case (i.e., when TBoMS is configured/indicated for any PUSCH transmission and the slot where the corresponding PUSCH transmission starts according to time domain resource assignment information is a non-SBFD slot), the SBFD slots may not be included when determining PUSCH transmission slots for PUSCH transmission according to TBoMS.

Alternatively, the slot type for performing the corresponding PUSCH transmission may be determined based on the symbol type where DCI format transmission including scheduling control information for the corresponding TBoMS-based PUSCH transmission is performed.

Further, various combinations of the implicit configuration methods may be included in the disclosure. For example, when the slot where PUSCH transmission configured/indicated with TBoMS starts is an SBFD slot, the SBFD slots may be included when determining PUSCH transmission slots according to TBoMS. On the other hand, when the start slot is a non-SBFD slot, whether to include the SBFD slots when determining PUSCH transmission slots according to TBoMS may be additionally determined based on whether the frequency resources allocated for the corresponding PUSCH transmission fully overlap the UL subband. For example, in case of full overlap, the SBFD slots may be included when determining PUSCH transmission slots according to TBoMS. Otherwise (i.e., partial overlap or non-overlap), the SBFD slots may not be included when determining PUSCH transmission slots according to TBoMS.

Further, all combinations of the explicit configuration/indication methods and implicit configuration/indication methods may be included in the scope of the disclosure. For example, even when whether to support PUSCH transmission according to TBoMS for SBFD slots is explicitly configured or indicated, whether to include the SBFD slots when determining PUSCH transmission slots according to TBoMS may be additionally determined according to the implicit method mentioned above. For example, even when explicitly configured to include the SBFD slots when determining PUSCH transmission slots according to TBoMS (i.e., not to exclude), when PRBs for PUSCH transmission according to FDRA information of DCI format do not belong to the UL subband, the corresponding SBFD slots may not be included when determining PUSCH transmission slots according to TBoMS (i.e., not included in counting N·K slots according to TBoMS).

Further, when transmission according to TBoMS across the different slot types mentioned above is configured/indicated to be supported or when whether to support PUSCH transmission according to TBoMS through SBFD slots is configured/indicated, a new rule for association (or mapping) between frequency resources between non-SBFD slots and SBFD slots may be configured or defined. For example, in the case of non-SBFD slots (e.g., UL slot), frequency resource allocation for PUSCH transmission of the UE in the corresponding slot may be performed based on the activated UL BWP of the corresponding UE. On the other hand, in SBFD slots, UL transmission may be performed only through the overlapped region of the activated UL BWP and UL subband.

Accordingly, when PUSCH transmission according to TBoMS across the different slot types mentioned above is configured/indicated to be supported, a frequency domain resource set for PUSCH transmission across the SBFD slots and non-SBFD slots may be configured in the UL BWP of the corresponding UE. Accordingly, association (mapping) between PRBs of the configured resource set and PRBs constituting UL subband or overlapped PRBs (physical resource blocks) between UL subband and UL BWP is performed. In this case, only one resource set may be configured for any UL BWP, or one or more resource sets may be configured so that all frequency resources of the corresponding UL BWP, i.e., PRBs, belong to at least one resource set. When one or more resource sets are configured, association (mapping) between PRBs of each resource set and PRBs constituting UL subband or overlapped PRBs between UL subband and UL BWP is performed. Any resource set configuration information may include start resource block (RB) information and size information on the frequency axis or include only start RB information. Size information may be determined based on the size of the UL subband or the size of overlapping frequency resources between UL subband and UL BWP.

Further, when PUSCH repetition and TB processing over multiple slots are simultaneously configured/indicated, the content may be equally applied to PUSCH transmission slots according to all TB processing over multiplex slots configuration/indication belonging to each PUSCH repetition.

Further, the PUSCH transmission based on different slot types may vary according to whether intra-slot/inter-slot frequency hopping is applied. For example, PUSCH transmission based on the different slot types may be limited to be supported only when frequency hopping is not applied.

When to support PUSCH transmission according to TBoMS is configured only through non-SBFD slots according to the explicit or implicit configuration mentioned above (i.e., when implicitly or explicitly configured to exclude SBFD slots while determining PUSCH transmission slots according to the TBoMS), PUSCH transmission slots according to TBoMS at the corresponding UE may be determined as follows.
1. When a UE is explicitly or implicitly configured not to include SBFD slots in PUSCH transmission slots according to TBoMS according to the methods mentioned above, the corresponding UE defines to count N·K slots according to numberOfSlotsTBoMS, N, excluding slots that satisfies the following conditions when determining PUSCH transmission slots for TB processing over multiple slots scheduled by DCI format 0_1 or DCI format 0_2. (Here, K is the pusch-AggregationFactor configuration value for the corresponding PUSCH repetition when PUSCH repetition is configured, or the PUSCH repetition count according to when TDRA configuration and indication including numberOfRepetitions is made.)
a. When at least one symbol among the symbols according to time domain resource allocation information for PUSCH transmission under the corresponding TBoMS in any slot is indicated as a DL symbol by tdd-UL-DL-ConfigurationCommon or tdd-UL-DL-ConfigurationDedicated
b. When at least one symbol among the symbols according to time domain resource allocation information for PUSCH transmission under the corresponding TBoMS in any slot is indicated as an SS/PBCH block symbol by index information of ssb-PositionsInBurst

On the other hand, when supporting PUSCH transmission according to TBoMS in non-SBFD slots and SBFD slots according to the explicit or implicit configuration mentioned above, i.e., when implicitly or explicitly configured to include SBFD slots while determining PUSCH transmission slots according to the TBoMS, PUSCH transmission slots according to TBoMS at the corresponding UE may be determined as follows.
1. When a UE is explicitly or implicitly configured to include SBFD slots in PUSCH transmission slots according to TBoMS according to the methods mentioned above, the corresponding UE defines to count N·K slots according to numberOfSlotsTBoMS, N, excluding slots that satisfies the following conditions when determining PUSCH transmission slots for TB processing over multiple slots scheduled by DCI format 0_1 or DCI format 0_2. (Here, K is the pusch-AggregationFactor configuration value for the corresponding PUSCH repetition when PUSCH repetition is configured, or the PUSCH repetition count according to when TDRA configuration and indication including numberOfRepetitions is made.)
a. When at least one symbol among the symbols according to time domain resource allocation information for PUSCH transmission under the corresponding TBoMS for any slot is a non-SBFD symbol and indicated as a DL symbol by tdd-UL-DL-ConfigurationCommon or tdd-UL-DL-ConfigurationDedicated
b. When at least one symbol among the symbols according to time domain resource allocation information for PUSCH transmission according to the corresponding TBoMS for any slot is an SBFD symbol and indicated as a DL symbol according to the extended slot configuration below
c. When at least one symbol among the symbols according to time domain resource allocation information for PUSCH transmission according to the corresponding TBoMS for any slot is indicated as an SS/PBCH block symbol based on index information of ssb-PositionsInBurst

Alternatively, when supporting PUSCH transmission according to TBoMS in non-SBFD slots and SBFD slots according to the explicit or implicit configuration mentioned above, i.e., when implicitly or explicitly configured to include SBFD slots when determining PUSCH transmission slots according to the TBoMS, PUSCH transmission slots according to TBoMS at the corresponding UE may be determined as follows.
1. When a UE is explicitly or implicitly configured to include SBFD slots in PUSCH transmission slots according to TBoMS based on the methods mentioned above, the corresponding UE defines to count N·K slots according to numberOfSlotsTBoMS, N, excluding slots that satisfies the following conditions when determining PUSCH transmission slots for TB processing over multiple slots scheduled by DCI format 0_1 or DCI format 0_2. (Here, K is the pusch-AggregationFactor configuration value for the corresponding PUSCH repetition when PUSCH repetition is configured, or the PUSCH repetition count according to when TDRA configuration and indication including numberOfRepetitions is made.)
a. When at least one symbol among the symbols according to time domain resource allocation information for PUSCH transmission according to the corresponding TBoMS for any slot is a non-SBFD symbol and indicated as a DL symbol by tdd-UL-DL-ConfigurationCommon or tdd-UL-DL-ConfigurationDedicated
b. When at least one symbol among the symbols according to time domain resource allocation information for PUSCH transmission under the corresponding TBoMS for any slot is an SBFD symbol and indicated as a DL symbol according to the extended slot configuration below
c. When at least one symbol among the symbols according to time domain resource allocation information for PUSCH transmission under the corresponding TBoMS for any slot is an SBFD symbol indicated as a UL symbol according to the extended slot configuration below, but the corresponding symbol is configured/indicated by the base station to fall back to a DL symbol that is a legacy TDD configuration (when the corresponding legacy TDD configuration is DL)
d. When at least one symbol among the symbols according to time domain resource allocation information for PUSCH transmission based on the corresponding TBoMS for any slot is indicated as an SS/PBCH block symbol by index information of ssb-PositionsInBurst

Alternatively, when supporting PUSCH transmission according to TBoMS in non-SBFD slots and SBFD slots according to the explicit or implicit configuration mentioned above, i.e., when implicitly or explicitly configured to include SBFD slots while determining PUSCH transmission slots according to the TBoMS, PUSCH transmission slots according to TBoMS at the corresponding UE may be determined as follows.
1. When a UE is explicitly or implicitly configured to include SBFD slots in PUSCH transmission slots according to TBoMS according to the methods mentioned above, the corresponding UE defines to count N·K slots according to numberOfSlotsTBoMS, N, excluding slots that satisfies the following conditions when determining PUSCH transmission slots for TB processing over multiple slots scheduled by DCI format 0_1 or DCI format 0_2. (Here, K is the pusch-AggregationFactor configuration value for the corresponding PUSCH repetition when PUSCH repetition is configured, or the PUSCH repetition count according to when TDRA configuration and indication including numberOfRepetitions is made.)
a. When at least one symbol among the symbols according to time domain resource allocation information for PUSCH transmission under the corresponding TBoMS for any slot is a non-SBFD symbol and indicated as a DL symbol by tdd-UL-DL-ConfigurationCommon or tdd-UL-DL-ConfigurationDedicated
b. When at least one symbol among the symbols according to time domain resource allocation information for PUSCH transmission under the corresponding TBoMS for any slot is indicated as an SS/PBCH block symbol by index information of ssb-PositionsInBurst

Finally, when supporting PUSCH transmission according to TBoMS only in SBFD slots according to the explicit or implicit configuration mentioned above (i.e., when explicitly or implicitly configured/indicated not to support PUSCH transmission according to the TBoMS in non-SBFD slots), PUSCH transmission slots according to TBoMS at the corresponding UE may be determined as follows.
1. When any UE is explicitly or implicitly configured to include only SBFD slots in PUSCH transmission slots according to TBoMS according to the methods mentioned above, the corresponding UE defines to count N·K slots according to numberOfSlotsTBoMS, N, excluding slots that satisfies the following conditions when determining PUSCH transmission slots for TB processing over multiple slots scheduled by DCI format 0_1 or DCI format 0_2. (Here, K is the pusch-AggregationFactor configuration value for the corresponding PUSCH repetition when PUSCH repetition is configured, or the PUSCH repetition count according to when TDRA configuration and indication including numberOfRepetitions is made.)
a. When at least one symbol among the symbols according to time domain resource allocation information for PUSCH transmission under the corresponding TBoMS for any slot is a non-SBFD symbol
b. When at least one symbol among the symbols according to time domain resource allocation information for PUSCH transmission under the corresponding TBoMS for any slot is an SBFD symbol and indicated as a DL symbol according to the extended slot configuration below
c. When at least one symbol among the symbols according to time domain resource allocation information for PUSCH transmission under the corresponding TBoMS for any slot is indicated as an SS/PBCH block symbol by index information of ssb-PositionsInBurst

Alternatively, when supporting PUSCH transmission according to TBoMS only in SBFD slots according to the explicit or implicit configuration mentioned above (i.e., when explicitly or implicitly configured/indicated not to support PUSCH transmission according to the TBoMS in non-SBFD slots), PUSCH transmission slots according to TBoMS at the corresponding UE may be determined as follows.
1. When any UE is explicitly or implicitly configured to include only SBFD slots in PUSCH transmission slots according to TBoMS according to the methods mentioned above, the corresponding UE defines to count N·K slots according to numberOfSlotsTBoMS, N, excluding slots that satisfies the following conditions when determining PUSCH transmission slots for TB processing over multiple slots scheduled by DCI format 0_1 or DCI format 0_2. (Here, K is the pusch-AggregationFactor configuration value for the corresponding PUSCH repetition when PUSCH repetition is configured, or the PUSCH repetition count according to when TDRA configuration and indication including numberOfRepetitions is made.)
a. When at least one symbol among the symbols according to time domain resource allocation information for PUSCH transmission under the corresponding TBoMS for any slot is a non-SBFD symbol
b. When at least one symbol among the symbols according to time domain resource allocation information for PUSCH transmission under the corresponding TBoMS for any slot is indicated as an SS/PBCH block symbol by index information of ssb-PositionsInBurst

Alternatively, when supporting PUSCH transmission according to TBoMS only in SBFD slots according to the explicit or implicit configuration mentioned above (i.e., when explicitly or implicitly configured/indicated not to support PUSCH transmission according to the TBoMS in non-SBFD slots), PUSCH transmission slots according to TBoMS at the corresponding UE may be determined as follows.
1. When any UE is explicitly or implicitly configured to include only SBFD slots in PUSCH transmission slots according to TBoMS according to the methods mentioned above, the corresponding UE defines to count N·K slots according to numberOfSlotsTBoMS, N, excluding slots that satisfies the following conditions when determining PUSCH transmission slots for TB processing over multiple slots scheduled by DCI format 0_1 or DCI format 0_2. (Here, K is the pusch-AggregationFactor configuration value for the corresponding PUSCH repetition when PUSCH repetition is configured, or the PUSCH repetition count according to when TDRA configuration and indication including numberOfRepetitions is made.)
a. When at least one symbol among the symbols according to time domain resource allocation information for PUSCH transmission under the corresponding TBoMS for any slot is a non-SBFD symbol
b. When at least one symbol among the symbols according to time domain resource allocation information for PUSCH transmission under the corresponding TBoMS for any slot is an SBFD symbol and indicated as a DL symbol according to the extended slot configuration below
c. When at least one symbol among the symbols according to time domain resource allocation information for PUSCH transmission under the corresponding TBoMS for any slot is a symbol configured or indicated by the base station to fallback to a legacy TDD configuration
d. When at least one symbol among the symbols according to time domain resource allocation information for PUSCH transmission under the corresponding TBoMS for any slot is indicated as an SS/PBCH block symbol by index information of ssb-PositionsInBurst

### Embodiment 2. Extended Slot Format Configuration

The base station may be defined to explicitly configure or indicate the transmission direction of the UE (or may be referred to by various names such as extended slot configuration, extended slot format, etc., and is not limited to specific names) for any SBFD slot or SBFD symbol in the corresponding slot or symbol. In other words, whether to perform DL reception operation or UL transmission operation in SBFD symbols or slots for any UE may be configured or indicated by the base station. For example, it may be defined that the base station transmits UL-DL configuration information of SBFD slots or symbols for any UE through UE-specific or cell-specific RRC signaling. The corresponding configuration information allows UL and DL configuration to be made targeting the corresponding SBFD slots or symbols based on period information of SBFD slots or symbols according to the UL subband configuration, and SBFD symbols not explicitly configured as UL or DL may implicitly mean that they are configured as flexible symbols. As another method, the base station may transmit UL-DL indication information of the corresponding SBFD slot or SBFD symbol to the UE through L1 control signaling. In this case, UL-DL indication information in the corresponding SBFD slot or SBFD symbol may be indicated through UE-specific DCI or UE-group common DCI.

The transmission direction configuration or indication information of the SBFD slot or symbol above may include the corresponding information in existing RRC signaling or DCI format, or separate RRC signaling or DCI format may be defined.

Alternatively, the transmission direction in a SBFD slot or symbol may be implicitly configured by UL subband configuration information. For example, when a UL subband configuration is applied in a DL slot/symbol or flexible slot/symbol, by the legacy slot configuration for a UE, the corresponding UE may implicitly perform UL transmission operation in the corresponding SBFD slot or symbol. Conversely, when DL subband configuration is performed, the corresponding UE may perform DL reception operation in the corresponding SBFD slot or symbol.

As described above, when the transmission direction for a UE in a SBFD slot or symbol is not configured as DL, i.e., when the transmission direction is UL or flexible, the corresponding UE supports PUSCH transmission in the corresponding SBFD slot or symbol.

Accordingly, when a SBFD slot is determined as a PUSCH transmission slot according to the method for determining slots for PUSCH transmission according to TBoMS by UL grant (e.g., DCI format 0_1, 0_2, etc.) of the above-described Embodiment 1, the UE may perform the PUSCH transmission operation in the corresponding SBFD slot as follows.

When scheduling for PUSCH transmission in a plurality of slots is performed by one DCI format for any UE, when at least one symbol among the symbols allocated for PUSCH transmission within any one of the corresponding plurality of slots is a non-SBFD symbol indicated as DL by tdd-UL-DL-ConfigurationCommon or tdd-UL-DL-ConfigurationDedicated, or at least one symbol is an SBFD symbol indicated as DL by the UE-specific or cell-specific extended slot configuration, it may be defined not to transmit PUSCH in the corresponding slot.

In other words, when scheduling for PUSCH transmission in a plurality of slots is performed by one DCI format for any UE, when at least one symbol among the symbols allocated for PUSCH transmission within any one of the corresponding plurality of slots is indicated as DL by tdd-UL-DL-ConfigurationCommon or tdd-UL-DL-ConfigurationDedicated for which UL subband configuration is not performed, or when UL subband configuration is performed but configured by the base station to perform DL reception operation in the corresponding symbol, the corresponding UE may not transmit PUSCH in the corresponding slot.

Accordingly, when any SBFD slot is determined as a PUSCH transmission slot according to TBoMS by Embodiment 1, the UE may define that PUSCH transmission shall not be performed in the corresponding slot when at least one or more of the symbols allocated for PUSCH transmission in the corresponding slot is configured as DL by the extended slot configuration.

Further, when TBoMS-based PUSCH transmission is configured for any UE and TBoMS-based PUSCH transmission through different slot types is explicitly or implicitly enabled by the base station, a separate DCI format (e.g., DCI format 0_x) may be newly defined for this. When the corresponding DCI format is defined, the information field of the corresponding DCI format may be divided into slot type common information area and slot type specific information area. The slot type common information area may be an information area configured and applied identically to PUSCH transmission in non-SBFD slots and PUSCH transmission in SBFD slots and may have a single configuration value within the corresponding DCI format. For example, TDRA information area, etc. may be a slot type common information area and may include a single information area as before. On the other hand, the slot type specific information area may be an information area separately configured and applied for PUSCH transmission in non-SBFD slots and PUSCH transmission in SBFD slots, and the same information area may have a configuration value for non-SBFD slots and a separate configuration value for SBFD slots. For example, FDRA, TCI field, etc. may be slot type specific information areas. However, regardless of the examples, all combinations in which predetermined information areas are applied commonly to slot types through configuration values while other information areas are configured separately for each slot type when configuring DCI format 0_x may be included in the disclosure.

All the examples above have been described based on slots on the time axis, but the corresponding content may be equally applied to various time resource units such as symbols, subframes, or frames.

With regard to the above-described embodiments, each embodiment falls within the scope of the disclosure, not only when implemented independently, but also when in combination with one or more other embodiments.

Hereinafter, configurations of a UE and a base station which may perform all or some of the embodiments described above in connection with FIGS. 1 to 11 are described with reference to the accompanying drawings. The description provided above may be omitted to avoid redundant description, and in this case, the omitted content may nevertheless be substantially applied to the following description as long as it does not conflict with the technical spirit of the disclosure.

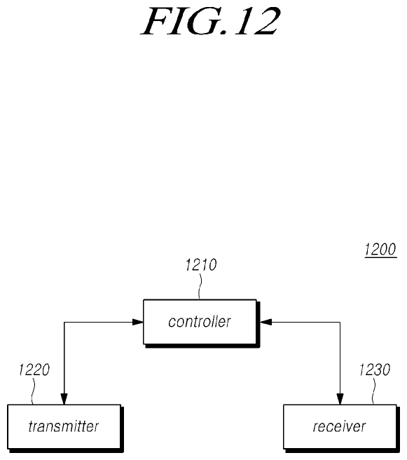

FIG. 12 is a block diagram illustrating a UE 1200 according to an embodiment.

Referring to FIG. 12, a UE 1200 according to an embodiment includes a transmitter 1220, a receiver 1230, and a controller 1210 controlling operations of the transmitter and the receiver.

The controller 1210 controls the overall operation of the UE 1200 according to the method for transmitting an uplink data channel in full-duplex communication required to the embodiments described above.

The controller 1210 may receive time division duplex (TDD) configuration information and subband configuration information. The controller 1210 may receive TDD configuration information from a base station to determine the symbol format. In this case, the TDD configuration information may include configuration information about the slot format and configuration information for determining the symbol format in the slot, and the corresponding information may be received through higher layer signaling or physical layer L1 signaling.

Further, the controller 1210 may receive UE-specific RRC signaling in which flexible symbols among the symbols configured through cell-specific RRC signaling are reallocated to uplink symbols, downlink symbols, or flexible symbols on a per-UE basis.

Alternatively, the controller 1210 may receive an indication of a dynamic slot format through a UE-group common PDCCH. According to an example, the controller 1210 may receive a dynamic slot format through DCI format 2_0.

The controller 1210 may receive subband configuration information for full-duplex communication. In other words, the UE may receive configuration information for configuring a downlink subband in an uplink slot or an uplink subband in a downlink slot. The subband configuration information may include time-domain information and frequency-domain information where an uplink subband or a downlink subband is configured. Alternatively, the subband configuration information may include frequency-domain information and time-domain information where a guard band is configured.

The controller 1210 may receive PUSCH configuration information including slot number configuration information for transmitting a PUSCH including one transport block (TB). The controller 1210 may receive, from the base station, the PUSCH configuration information configuring or indicating transmission of one transport block across a plurality of slots. In other words, for PUSCH transmission, TB processing over multiple slots (TBoMS) may be configured or indicated. To that end, an information element configured in RRC, e.g., PUSCH-TimeDomainResourceAllocationList, may include time domain allocation configuration information areas.

In this case, the time domain allocation configuration information may include configuration information about the numbers of a plurality of slots in which one transport block is transmitted. According to an example, the number of the plurality of slots may be configured as 1 (in case of conventional single slot processing), 2, 4, or 8 consecutive slots.

The controller 1210 may determine a plurality of slots for transmitting the PUSCH including the one transport block based on the downlink control information including the PUSCH configuration information and the PUSCH resource allocation information. The controller 1210 may transmit the PUSCH including the one transport block through the determined plurality of slots.

The controller 1210 may be indicated (e.g., instructed) by the base station through a time domain resource assignment (TDRA) indication information area of DCI, i.e., an uplink grant (UL grant), to transmit one transport block transmitted through the corresponding PUSCH transmission across a plurality of slots for PUSCH transmission. In other words, one time domain allocation configuration information among the time domain allocation configuration information areas belonging to the above-described PUSCH-TimeDomainResourceAllocationList may be indicated through the time domain resource allocation indication information area. In this case, when the corresponding time domain allocation information includes information about the number of a plurality of slots for transmitting one transport block, it may be configured and indicated that the corresponding one transport block, i.e., the corresponding PUSCH transmission, is performed through consecutive slots corresponding to one of 1, 2, 4, or 8 according to the configuration value of the information about the number of the plurality of slots.

As such, when one PUSCH transmission is performed across a plurality of slots through TBoMS configuration or indication, slots configured or indicated for uplink transmission at the UE may belong to different slot types.

The plurality of slots for transmitting the PUSCH including the one transport block may include at least one of i) a slot where symbols allocated for the PUSCH transmission within each slot are configured as non-subband full duplex (non-SBFD) symbols that are uplink (UL) or flexible according to the TDD configuration information, not including SSB reception symbols, or ii) a slot in which the symbols are reset as SBFD symbols configured as downlink (DL) or flexible according to the TDD configuration information and in which an uplink subband is configured according to the subband configuration information.

In other words, the plurality of slots for transmitting one transport block should not include SSB reception symbols among the symbols allocated for PUSCH transmission within a slot and may be configured to include either only non-SBFD slots, only SBFD slots, or both. Here, an SBFD slot and a non-SBFD slot may each represent a slot type.

Therefore, the controller 1210 may determine the plurality of slots based on whether to include SBFD slots (composed of SBFD symbols) and non-SBFD slots (composed of non-SBFD symbols) in the plurality of slots based on the configuration by the base station. To that end, the controller 1210 may receive enable/disable information for PUSCH transmission according to TBoMS across different slot types explicitly or implicitly from the base station.

The controller 1210 may be explicitly configured with activation of PUSCH transmission according to TBoMS through different slot types from the base station through cell-specific or UE-specific RRC signaling. Alternatively, the controller 1210 may be explicitly indicated to activate PUSCH transmission according to TBoMS across different slot types from the base station through a DCI format or an uplink grant of RAR. Alternatively, activation of PUSCH transmission according to TBoMS through different slot types may be implicitly configured by FDRA information for PUSCH transmission or type information of the first PUSCH transmission slot, information of DCI format reception slot type including PUSCH scheduling control information, etc. Alternatively, it may be configured as a combination of the above-described explicit configuration and implicit configuration.

When PUSCH transmission according to TBoMS through different slot types is activated, the controller 1210 may include both non-SBFD slots and SBFD slots when counting a plurality of slots capable of PUSCH transmission. However, the controller 1210 may determine the plurality of slots excluding a slot that includes a symbol configured or indicated by the base station to receive downlink among the SBFD symbols where symbols allocated for PUSCH transmission within the slot include such symbol.

In other words, SBFD symbols within an SBFD slot include both an uplink subband and a downlink subband based on the TDD configuration information and the subband configuration information, and the base station may configure or indicate a transmission direction of SBFD symbols as UL or DL. Therefore, when at least one of the SBFD symbols allocated for PUSCH transmission within an SBFD slot is configured or indicated with a transmission direction as downlink by the base station, a slot including the corresponding symbol may be excluded from counting the plurality of slots. This may equally apply even when PUSCH transmission according to TBoMS through different slot types is deactivated and configured as an SBFD slot type for PUSCH transmission according to TBoMS.

Hereinafter, when PUSCH transmission according to TBoMS through different slot types is activated, a specific example of determining a plurality of slots used for PUSCH transmission according to TBoMS is described.

According to an embodiment, when supporting PUSCH transmission according to TBoMS in non-SBFD slots and SBFD slots according to explicit or implicit configuration, i.e., when implicitly or explicitly configured to include SBFD slots in determining the PUSCH transmission slots according to the TBoMS, the PUSCH transmission slots according to TBoMS at the corresponding UE may be determined as follows.

When explicitly or implicitly configured to include SBFD slots in addition to non-SBFD slots in PUSCH transmission slots according to TBoMS, the UE may count N·K slots according to the number N of slots for transmitting one transport block, excluding slots that satisfy the following conditions, when determining PUSCH transmission slots according to TBoMS scheduled by DCI format 0_1 or DCI format 0_2. Here, K may be the PUSCH repetition count according to a pusch-AggregationFactor configuration value for the PUSCH repetition when PUSCH repetition is configured, or when TDRA configuration and indication including numberOfRepetitions is made. N and K may be used identically hereinafter.

In this case, for each slot, when at least one symbol among the symbols according to the time domain resource allocation information for PUSCH transmission according to the corresponding TBoMS is a non-SBFD symbol and indicated as a DL symbol by the TDD configuration information, the corresponding slot may be excluded from counting. Further, for each slot, when at least one symbol among the symbols according to the time domain resource allocation information for PUSCH transmission according to the corresponding TBoMS is an SBFD symbol and indicated as a DL symbol, the corresponding slot may be excluded from counting. Further, for each slot, when at least one symbol among the symbols according to the time domain resource allocation information for PUSCH transmission according to the corresponding TBoMS includes an SS/PBCH block by SSB-PositionInBurst, the corresponding slot may be excluded from slot counting. Alternatively, for each slot, when at least one symbol among the symbols according to the time domain resource allocation information for PUSCH transmission according to TBoMS is an SBFD symbol indicated as a UL symbol, but the corresponding symbol is configured or indicated by the base station to fall back to a DL symbol that is a legacy TDD configuration, the corresponding slot may be excluded from slot counting. In other cases, the UE may configure consecutive N·K slots as PUSCH transmission slots according to TBoMS.

According to another embodiment, when PUSCH transmission according to TBoMS through different slot types is deactivated, the controller 1210 may determine the plurality of slots according to only one of the slot types classified as slots including SBFD symbols or slots including non-SBFD symbols. In other words, the plurality of slots for PUSCH transmission according to TBoMS may be counted only as SBFD slots or only as non-SBFD slots.

In this case, the slot type for determining the plurality of slots for PUSCH transmission according to TBoMS may be configured or indicated by the base station, determined by the type of symbol where the downlink control information including the scheduling information of PUSCH was received, or determined based on the symbol type of the first slot among the plurality of slots. In other words, when PUSCH transmission according to TBoMS through different slot types is deactivated, the slot type for performing PUSCH transmission according to TBoMS may be determined based on the reception slot type of the DCI format including the scheduling control information for the corresponding PUSCH, or may be determined based on the first PUSCH transmission slot type by the DCI format. Alternatively, slot type configuration information or indication information for PUSCH transmission according to TBoMS may be transmitted by the base station through RRC signaling or through the corresponding DCI format.

Hereinafter, when PUSCH transmission according to TBoMS through different slot types is deactivated and the slot type used for PUSCH transmission according to TBoMS is configured or indicated as a non-SBFD slot, a specific example of determining a plurality of slots used for PUSCH transmission according to TBoMS is described.

When the UE (or the controller 1210) is explicitly or implicitly configured not to include SBFD slots in the PUSCH transmission slots for TBoMS, the controller 1210 may count N·K slots excluding slots that satisfy the following conditions when determining PUSCH transmission slots according to TBoMS scheduled by DCI format 0_1 or DCI format 0_2.

In this case, for each slot, when at least one symbol among the symbols according to the time domain resource allocation information for PUSCH transmission according to the corresponding TBoMS is indicated as a DL symbol by the TDD configuration information, the corresponding slot may be excluded from counting. Further, for each slot, when at least one of the symbols according to the time domain resource allocation information for PUSCH transmission according to the corresponding TBoMS is indicated as an SS/PBCH block symbol by index information of ssb-PositionsInBurst, the corresponding slot may be excluded from counting.

Hereinafter, when PUSCH transmission according to TBoMS through different slot types is deactivated and the slot type used for PUSCH transmission according to TBoMS is configured or indicated as an SBFD slot, a specific example of determining a plurality of slots used for PUSCH transmission according to TBoMS is described.

When the controller 120 is explicitly or implicitly configured to include only SBFD slots in the PUSCH transmission slots for TBoMS, the controller 1210 may count N·K slots excluding slots that satisfy the following conditions when determining PUSCH transmission slots according to TBoMS scheduled by DCI format 0_1 or DCI format 0_2.

In this case, for each slot, when at least one of the symbols according to the time domain resource allocation information for PUSCH transmission under the corresponding TBoMS is a non-SBFD symbol, the corresponding slot may be excluded from counting. Further, for each slot, when at least one of the symbols according to the time domain resource allocation information for PUSCH transmission according to the corresponding TBoMS is an SBFD symbol and indicated as a DL symbol, the corresponding slot may be excluded from counting. Further, for each slot, when at least one of the symbols according to the time domain resource allocation information for PUSCH transmission according to the corresponding TBoMS is indicated as an SS/PBCH block symbol by index information of ssb-PositionsInBurst, the corresponding slot may be excluded from counting. Further, for each slot, when at least one of the symbols according to the time domain resource allocation information for PUSCH transmission according to the corresponding TBoMS is a symbol configured or indicated by the base station to fall back to a legacy TDD configuration, the corresponding slot may be excluded from counting.

According to an embodiment, when a plurality of slots for PUSCH transmission according to TBoMS includes both i) slots including SBFD symbols and ii) slots including non-SBFD symbols, the controller 1210 may transmit PUSCH according to separately defined downlink control information for PUSCH transmission according to TBoMS.

In other words, when PUSCH transmission according to TBoMS is configured for the UE and PUSCH transmission according to TBoMS through different slot types is explicitly or implicitly activated by the base station, a separate DCI format, e.g., DCI format 0_x, may be newly defined for this. When a DCI format is separately defined, the information field (e.g., information area) of the corresponding DCI format may be configured by being divided into a slot type common information area and a slot type specific information area.

In this case, the slot type common information area may be an information area that may be configured and applied identically to PUSCH transmission in non-SBFD slots and PUSCH transmission in SBFD slots. Therefore, it may have one configuration value within the corresponding DCI format. For example, a TDRA information area, etc. may be a slot type common information area and may include a single information area as before.

On the other hand, the slot type specific information area may be an information area that is separately configured and applied for PUSCH transmission in non-SBFD slots and PUSCH transmission in SBFD slots. Therefore, the same information area may have a configuration value for non-SBFD slots and a separate configuration value for SBFD slots, respectively. For example, FDRA, TCI field, etc. may be slot type specific information areas.

However, the content is provided as an example, and all combinations in which predetermined information areas are applied commonly to slot types through configuration values while other information areas are configured separately for each slot type when configuring DCI format 0_x may be included in the disclosure.

After determining the plurality of slots for PUSCH transmission according to TBoMS, the controller 1210 may transmit the PUSCH according to TBoMS to the base station through at least some slots among the determined plurality of slots. In other words, the controller 1210 may count a plurality of slots that may be used for PUSCH transmission according to TBoMS, and then transmit PUSCH using all or some of the corresponding plurality of slots according to the circumstance configured for the UE.

According to the embodiments described above, an uplink data channel may be efficiently transmitted and received within slots or symbols where full duplex communication is applied.

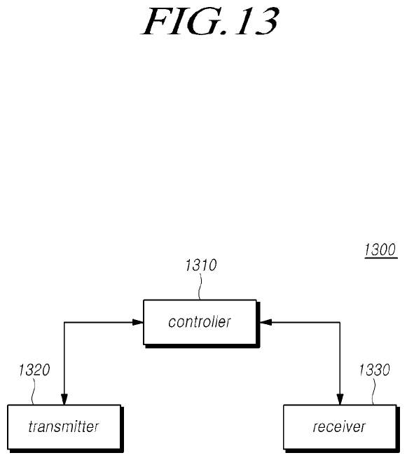

FIG. 13 is a block diagram illustrating a base station 1300 according to an embodiment.

Referring to FIG. 13, a base station 1300 according to an embodiment includes a transmitter 1320, a receiver 1330, and a controller 1310 controlling operations of the transmitter and the receiver.

The controller 1310 controls the overall operation of the base station 1300 according to the method for receiving an uplink data channel in full-duplex communication required to the embodiments described above. The transmitter 1320 transmits downlink control information and data or messages to the UE via a corresponding channel. The receiver 1330 receives uplink control information and data or messages from the UE via a corresponding channel.

The controller 1310 may transmit time division duplex (TDD) configuration information and subband configuration information. The controller 1310 may transmit TDD configuration information to the UE to determine the symbol format within a slot. In this case, the TDD configuration information may include configuration information about the format of the slot and configuration information for determining the format of the symbol in the slot, and the corresponding information may be received through higher layer signaling or physical layer L1 signaling.

Alternatively, the controller 1310 may indicate a dynamic slot format through UE-group common PDCCH. According to an embodiment, the controller 1310 may dynamically indicate a slot format through DCI format 2_0.

The controller 1310 may transmit subband configuration information for full-duplex communication to the UE. In other words, the base station may transmit configuration information for configuring a downlink subband in an uplink slot or an uplink subband in a downlink slot. The subband configuration information may include time-domain information and frequency-domain information where an uplink subband or a downlink subband is configured. Alternatively, the subband configuration information may include frequency-domain information and time-domain information where a guard band is configured.

The controller 1310 may transmit PUSCH configuration information including slot number configuration information for transmitting a PUSCH including one transport block (TB). The controller 1310 may transmit to the UE the PUSCH configuration information configuring or indicating transmission of one transport block across a plurality of slots. In other words, the controller 1310 may configure or indicate TB processing over multiple slots (TBoMS) for PUSCH transmission. To that end, an information element configured in RRC, e.g., PUSCH-TimeDomainResourceAllocationList, may include time domain allocation configuration information areas.

In this case, the time domain allocation configuration information may include configuration information about the numbers of a plurality of slots for transmitting one transport block. According to an embodiment, the number of the plurality of slots may be configured as 1 (in case of conventional single slot processing), 2, 4, or 8 consecutive slots.

The controller 1310 may configure whether to enable transmission of the PUSCH including the one transport block across slots of different slot types. The controller 1310 may receive the PUSCH including the one transport block through a plurality of slots determined based on whether the transmission of the PUSCH including the one transport block is enabled.

The controller 1310 may indicate through a time domain resource assignment (TDRA) indication information area of DCI, i.e., an uplink grant (UL grant), to transmit one transport block across a plurality of slots for PUSCH transmission of the UE. In other words, one time domain allocation configuration information among the time domain allocation configuration information areas belonging to the above-described PUSCH-TimeDomainResourceAllocationList may be indicated through the time domain resource allocation indication information area. In this case, when the corresponding time domain allocation information includes information about the number of a plurality of slots for transmitting one transport block, it may be configured and indicated that the corresponding one transport block, i.e., the corresponding PUSCH transmission, is performed through consecutive slots corresponding to one of 1, 2, 4, or 8 according to the configuration value of the information about the number of the plurality of slots.

As such, when one PUSCH transmission is performed across a plurality of slots through TBoMS configuration or indication, slots configured or indicated for uplink transmission at the UE may belong to different slot types.

The plurality of slots for transmitting the PUSCH including the one transport block may include at least one of: i) a slot in which the symbols allocated for the PUSCH transmission within each slot, excluding SSB reception symbols, are configured as non-subband full duplex (non-SBFD) symbols that are all uplink (UL) or flexible according to the TDD configuration information, or ii) a slot in which the symbols are reset as SBFD symbols configured as downlink (DL) or flexible according to the TDD configuration information and in which an uplink subband is defined according to the subband configuration information.

In other words, the plurality of slots for transmitting one transport block should not include SSB reception symbols among the symbols allocated for PUSCH transmission within a slot and may be configured to include either only non-SBFD slots, only SBFD slots, or both. Here, an SBFD slot and a non-SBFD slot may each represent a slot type.

Therefore, the UE may determine the plurality of slots according to whether to include SBFD slots (composed of SBFD symbols) and non-SBFD slots (composed of non-SBFD symbols) in the plurality of slots based on the configuration by the base station. To that end, the controller 1310 may transmit enable/disable information for PUSCH transmission according to TBoMS across different slot types explicitly or implicitly to the UE.

The controller 1310 may explicitly configure activation of PUSCH transmission according to TBoMS through different slot types to the UE through cell-specific or UE-specific RRC signaling. Alternatively, the controller 1310 may explicitly indicate (e.g., instruct) activation of PUSCH transmission according to TBoMS through different slot types to the UE through a DCI format or an uplink grant of RAR. Alternatively, activation of PUSCH transmission according to TBoMS through different slot types may be implicitly configured by FDRA information for PUSCH transmission or type information of the first PUSCH transmission slot, information of DCI format reception slot type including PUSCH scheduling control information, etc. Alternatively, it may be configured as a combination of the above-described explicit configuration and implicit configuration.

When PUSCH transmission according to TBoMS through different slot types is activated, the UE may include both non-SBFD slots and SBFD slots when counting a plurality of slots capable of PUSCH transmission. However, the UE may determine the plurality of slots excluding a slot that includes a symbol configured or indicated by the controller 1310 to receive downlink among the SBFD symbols where symbols allocated for PUSCH transmission within the slot include such symbol.

In other words, SBFD symbols within an SBFD slot include both an uplink subband and a downlink subband based on the TDD configuration information and the subband configuration information, and the controller 1310 may configure or indicate the transmission direction of SBFD symbols as UL or DL. Therefore, when at least one of the SBFD symbols allocated for PUSCH transmission within an SBFD slot is configured or indicated with a transmission direction as downlink by the base station, a slot including the corresponding symbol may be excluded from counting the plurality of slots. This may equally apply even when PUSCH transmission according to TBoMS through different slot types is deactivated and configured as an SBFD slot type for PUSCH transmission according to TBoMS.

Hereinafter, when PUSCH transmission according to TBoMS across different slot types is activated, a specific example of determining a plurality of slots used for PUSCH transmission according to TBoMS is described.

According to an embodiment, when supporting PUSCH transmission according to TBoMS in non-SBFD slots and SBFD slots according to explicit or implicit configuration, i.e., when implicitly or explicitly configured to include SBFD slots in determining the PUSCH transmission slots according to the TBoMS, the PUSCH transmission slots according to TBoMS at the corresponding UE may be determined as follows.

When explicitly or implicitly configured to include SBFD slots in addition to non-SBFD slots in PUSCH transmission slots according to TBoMS, the UE may count N·K slots according to the number N of slots for transmission of one transport block, excluding the slots that satisfy the following conditions, when determining PUSCH transmission slots according to TBoMS scheduled by DCI format 0_1 or DCI format 0_2.

In this case, for each slot, when at least one of the symbols according to the time domain resource allocation information for PUSCH transmission according to the corresponding TBoMS is a non-SBFD symbol and indicated as a DL symbol by the TDD configuration information, the corresponding slot may be excluded from counting. Further, for each slot, when at least one of the symbols according to the time domain resource allocation information for PUSCH transmission according to the corresponding TBoMS is an SBFD symbol and indicated as a DL symbol, the corresponding slot may be excluded from counting. Further, for each slot, when at least one of the symbols according to the time domain resource allocation information for PUSCH transmission according to the corresponding TBoMS includes an SS/PBCH block by SSB-PositionInBurst, the corresponding slot may be excluded from slot counting. Alternatively, for each slot, when at least one of the symbols according to the time domain resource allocation information for PUSCH transmission according to TBoMS is an SBFD symbol indicated as a UL symbol, but the corresponding symbol is configured or indicated by the controller 1310 to fall back to a DL symbol that is a legacy TDD configuration, the corresponding slot may be excluded from slot counting. In other cases, the UE may configure consecutive N·K slots as PUSCH transmission slots according to TBoMS.

According to another embodiment, when PUSCH transmission according to TBoMS through different slot types is deactivated, the UE may determine the plurality of slots according to only one of the slot types classified as slots including SBFD symbols or slots including non-SBFD symbols. In other words, the plurality of slots for PUSCH transmission according to TBoMS may be counted only as SBFD slots or only as non-SBFD slots.

In this case, the slot type for determining the plurality of slots for PUSCH transmission according to TBoMS may be configured or indicated by the controller 1310, determined by the symbol type where the downlink control information including the scheduling information of PUSCH was received, or determined by the symbol type of the first slot among the plurality of slots. In other words, when PUSCH transmission according to TBoMS through different slot types is deactivated, the slot type in which PUSCH transmission according to TBoMS is performed may be determined based on the reception slot type of the DCI format including the scheduling control information for the corresponding PUSCH, or may be determined based on the first PUSCH transmission slot type by the DCI format. Alternatively, the controller 1310 may transmit slot type configuration information or indication information for PUSCH transmission according to TBoMS through RRC signaling or through the corresponding DCI format.

Hereinafter, when PUSCH transmission according to TBoMS across different slot types is deactivated and the slot type for PUSCH transmission according to TBoMS is configured or indicated as a non-SBFD slot, a specific example of determining a plurality of slots for PUSCH transmission according to TBoMS is described.

When it is explicitly or implicitly configured not to include SBFD slots in the PUSCH transmission slots for TBoMS, the UE may count N·K slots except for slots satisfying the following conditions when determining PUSCH transmission slots according to TBoMS scheduled by DCI format 0_1 or DCI format 0_2.

In this case, for each slot, when at least one symbol among symbols according to the time domain resource allocation information for PUSCH transmission according to the corresponding TBoMS is indicated as a DL symbol based on the TDD configuration information, the corresponding slot may be excluded from counting. Further, for each slot, when at least one of the symbols according to the time domain resource allocation information for PUSCH transmission according to the corresponding TBoMS is indicated as an SS/PBCH block symbol based on index information of ssb-PositionsInBurst, the corresponding slot may be excluded from counting.

Hereinafter, when PUSCH transmission according to TBoMS across different slot types is deactivated and the slot type for PUSCH transmission according to TBoMS is configured or indicated as an SBFD slot, a specific example of determining a plurality of slots used for PUSCH transmission according to TBoMS is described.

When it is explicitly or implicitly configured to include only SBFD slots in the PUSCH transmission slots for TBoMS, the UE may count N·K slots excluding slots that satisfy the following conditions when determining PUSCH transmission slots according to TBoMS scheduled by DCI format 0_1 or DCI format 0_2.

In this case, for each slot, when at least one of the symbols according to the time domain resource allocation information for PUSCH transmission according to the corresponding TBoMS is a non-SBFD symbol, the corresponding slot may be excluded from counting. Further, for each slot, when at least one of the symbols according to the time domain resource allocation information for PUSCH transmission according to the corresponding TBoMS is an SBFD symbol and indicated as a DL symbol, the corresponding slot may be excluded from counting. Further, for each slot, when at least one of the symbols according to the time domain resource allocation information for PUSCH transmission according to the corresponding TBoMS is indicated as an SS/PBCH block symbol based on index information of ssb-PositionsInBurst, the corresponding slot may be excluded from counting. Further, for each slot, when at least one of the symbols according to the time domain resource allocation information for PUSCH transmission according to the corresponding TBoMS is a symbol configured or indicated by the base station to fall back to a legacy TDD configuration, the corresponding slot may be excluded from counting.

According to an embodiment, when a plurality of slots for PUSCH transmission according to TBoMS includes both slots including SBFD symbols and slots including non-SBFD symbols, the controller 1310 may receive PUSCH according to separately defined downlink control information for PUSCH transmission according to TBoMS.

In other words, when PUSCH transmission according to TBoMS is configured for the UE and PUSCH transmission according to TBoMS across different slot types is explicitly or implicitly activated by the controller 1310, a separate DCI format, e.g., DCI format 0_x, may be newly defined for this. When a DCI format is separately defined, the information field (e.g., information area) of the corresponding DCI format may be configured by being divided into a slot type common information area and a slot type specific information area.

In this case, the slot type common information area may be an information area that may be configured and applied identically to PUSCH transmission in non-SBFD slots and PUSCH transmission in SBFD slots. Therefore, it may have one configuration value within the corresponding DCI format. For example, a TDRA information area, etc. may be a slot type common information area and may include a single information area as before.

On the other hand, the slot type specific information area may be an information area that is separately configured and applied for PUSCH transmission in non-SBFD slots and PUSCH transmission in SBFD slots. Therefore, the same information area may have a configuration value for non-SBFD slots and a separate configuration value for SBFD slots, respectively. For example, FDRA, TCI field, etc. may be slot type specific information areas.

However, the content is provided as an example, and all combinations in which predetermined information areas are applied commonly to slot types through configuration values while other information areas are configured separately for each slot type when configuring DCI format 0_x may be included in the disclosure.

After the UE determines the plurality of slots for PUSCH transmission according to TBoMS, the controller 1310 may receive the PUSCH according to TBoMS through at least some of the determined plurality of slots. In other words, the UE may determine a plurality of slots available for PUSCH transmission according to TBoMS and receive the PUSCH using all or some of those slots depending on the configuration applied to the UE.

According to the embodiments described above, an uplink data channel may be efficiently transmitted and received within slots or symbols where full duplex communication is applied.

The embodiments described above may be supported by the standard documents disclosed in at least one of the radio access systems such as IEEE 802, 3GPP, and 3GPP2. That is, the steps, configurations, and parts, which have not been described in the present embodiments, may be supported by the above-mentioned standard documents for clarifying the technical concept of the disclosure. In addition, all terms disclosed herein may be described by the standard documents set forth above.

The above-described embodiments may be implemented by any of various means. For example, the present embodiments may be implemented as hardware, firmware, software, or a combination thereof.

In the case of implementation by hardware, the method according to the present embodiments may be implemented as at least one of an application specific integrated circuit (ASIC), a digital signal processor (DSP), a digital signal processing device (DSPD), a programmable logic device (PLD), a field programmable gate array (FPGA), a processor, a controller, a microcontroller, or a microprocessor.

In the case of implementation by firmware or software, the method according to the present embodiments may be implemented in the form of an apparatus, a procedure, or a function for performing the functions or operations described above. Software code may be stored in a memory unit, and may be driven by the processor. The memory unit may be provided inside or outside the processor, and may exchange data with the processor by any of various well-known means.

In addition, the terms “system”, “processor”, “controller”, “component”, “module”, “interface”, “model”, “unit”, and the like may generally mean computer-related entity hardware, a combination of hardware and software, software, or running software. For example, the above-described components may be, but are not limited to, a process driven by a processor, a processor, a controller, a control processor, an entity, an execution thread, a program and/or a computer. For example, both the application that is running in a controller or a processor and the controller or the processor may be components. One or more components may be provided in a process and/or an execution thread, and the components may be provided in a single device (e.g., a system, a computing device, etc.), or may be distributed over two or more devices.

The above embodiments of the present disclosure have been described only for illustrative purposes, and those skilled in the art will appreciate that various modifications and changes may be made thereto without departing from the scope and spirit of the disclosure. Further, the embodiments of the disclosure are not intended to limit, but are intended to illustrate the technical idea of the disclosure, and therefore the scope of the technical idea of the disclosure is not limited by these embodiments. The scope of the present disclosure shall be construed on the basis of the accompanying claims in such a manner that all of the technical ideas included within the scope equivalent to the claims belong to the present disclosure.

### CROSS-REFERENCE TO RELATED APPLICATION

This application claims the benefit of Korean Patent Application No. 10-2023-0048381, filed on Apr. 12, 2023, and Korean Patent Application No. 10-2024-0048710, filed on Apr. 11, 2024, under 35 U.S.C. § 119 (a). The entire contents of the above applications are incorporated herein by reference. Further, this application also claims the right of priority with respect to countries other than the United States for the same reasons as above, and the entire contents thereof are incorporated herein by reference.

1-20. (canceled)

21. A method of a user equipment (UE) to transmit a physical uplink shared channel (PUSCH) including one transport block (TB) through a plurality of slots, the method comprising:
receiving PUSCH configuration information including Transport Block over Multi-Slot (TBoMS) configuration information for transmitting a PUSCH including one transport block (TB) through a plurality of slots;
determining available slot type for transmitting the PUSCH including the one transport block based on the TBoMS configuration information; and
transmitting the PUSCH including the one transport block according to the determined available slot type,
wherein the transmission of the PUSCH according to the TBoMS configuration information is performed through one of: (i) a first operation in which the PUSCH is transmitted only through subband full duplex (SBFD) slots each composed of SBFD symbols; (ii) a second operation in which the PUSCH is transmitted only through non-SBFD slots each composed of non-SBFD symbols; and (iii) a third operation in which the PUSCH is transmitted through both the SBFD slots and the non-SBFD slots.

22. The method of claim 21, wherein determining the available slot type comprises receiving, from a base station, configuration information indicating whether transmission of the PUSCH according to the TBoMS configuration information across different slot types is permitted.

23. The method of claim 21, wherein the available slot type is determined as a type of a first slot in which the PUSCH is transmitted when transmission of the PUSCH according to the TBoMS configuration information through different slot types is not permitted.

24. The method of claim 21, wherein the first operation is performed only in the SBFD slots that do not include an synchronization signal block (SSB).

25. The method of claim 21, wherein the second operation is performed only in the non-SBFD slots that (i) exclude an synchronization signal block (SSB) and (ii) exclude symbols configured as downlink (DL) according to TDD configuration information.

26. The method of claim 21, wherein the third operation is performed in the SBFD slots and in the non-SBFD slots that (i) exclude an SSB and (ii) exclude symbols configured as DL according to TDD configuration information.

27. A method of a base station to receive a physical uplink shared channel (PUSCH) including one transport block (TB) through a plurality of slots, the method comprising:
transmitting PUSCH configuration information including Transport Block over Multi-Slot (TBoMS) configuration information for transmission of a PUSCH including one transport block (TB) through a plurality of slots;
and
receiving the PUSCH including the one transport block through a plurality of slots according to the determined available slot type based on the TBoMS configuration information,
wherein the reception of the PUSCH according to the TBoMS configuration information is performed through one of: (i) a first operation in which the PUSCH is received only through subband full duplex (SBFD) slots each composed of SBFD symbols; (ii) a second operation in which the PUSCH is received only through non-SBFD slots each composed of non-SBFD symbols; and (iii) a third operation in which the PUSCH is received through both the SBFD slots and the non-SBFD slots.

28. The method of claim 27, wherein further comprising transmitting, to a user equipment (UE), configuration information indicating whether transmission of the PUSCH according to the TBoMS configuration information through different slot types is permitted.

29. The method of claim 27, wherein the available slot type is determined as a type of a first slot in which the PUSCH is received when reception of the PUSCH according to the TBoMS configuration information through different slot types is not permitted.

30. The method of claim 27, wherein the first operation is performed only in the SBFD slots that exclude an synchronization signal block (SSB).

31. The method of claim 27, wherein the second operation is performed only in the non-SBFD slots that (i) exclude an synchronization signal block (SSB) and (ii) exclude symbols configured as downlink (DL) according to TDD configuration information.

32. The method of claim 27, wherein the third operation is performed in the SBFD slots that exclude an synchronization signal block (SSB) and in the non-SBFD slots that (i) exclude an SSB and (ii) exclude symbols configured as DL according to time division duplex (TDD) configuration information.

33. A user equipment (UE) transmitting a physical uplink shared channel (PUSCH) including one transport block (TB) through a plurality of slots, the UE comprising:
a transmitter;
a receiver; and
a controller controlling an operation of the transmitter and the receiver, wherein the controller:
receives PUSCH configuration information including Transport Block over Multi-Slot (TBoMS) configuration information for transmission of a PUSCH including one transport block (TB) through a plurality of slots, determines available slot type for transmitting the PUSCH including the one transport block based on the TBoMS configuration information, and transmits the PUSCH including the one transport block according to the determined available slot type,
wherein the transmission of the PUSCH according to the TBoMS configuration information is performed through one of: (i) a first operation in which the PUSCH is transmitted only through subband full duplex (SBFD) slots each composed of SBFD symbols; (ii) a second operation in which the PUSCH is transmitted only through the non-SBFD slots each composed of non-SBFD symbols; and (iii) a third operation in which the PUSCH is transmitted through both the SBFD slots and the non-SBFD slots.

34. The UE of claim 33, wherein the controller determines the available slot type comprises receiving, from a base station, configuration information indicating whether transmission of the PUSCH according to the TBoMS configuration information across different slot types is permitted.

35. The UE of claim 33, wherein the controller determines the available slot type is determined as a type of a first slot in which the PUSCH is transmitted when transmission of the PUSCH according to the TBoMS configuration information through different slot types is not permitted.

36. The UE of claim 33, wherein the first operation is performed only in the SBFD slots that exclude an synchronization signal block (SSB).

37. The UE of claim 33, wherein the second operation is performed only in the non-SBFD slots that (i) exclude an synchronization signal block (SSB) and (ii) excludes symbols configured as downlink (DL) according to TDD configuration information.

38. The UE of claim 33, wherein the third operation is performed in the SBFD slots that exclude an synchronization signal block (SSB) and in the non-SBFD slots that (i) exclude an SSB and (ii) exclude symbols configured as DL according to time division duplex (TDD) configuration information.
